(19) United States
(12) Patent Application Publication
(10) Pub. No.: US 2013/0222884 A1
(43) Pub. Date: Aug. 29, 2013

(54) ELECTROPHORETIC PARTICLE, PARTICLE DISPERSION LIQUID FOR DISPLAY, DISPLAY MEDIUM AND DISPLAY DEVICE

(71) Applicants: FUJI XEROX CO., LTD., (US); FUJIFILM CORPORATION, (US)

(72) Inventors: Hiroaki MORIYAMA, Kanagawa (JP); Yasuo YAMAMOTO, Kanagawa (JP); Mieko SEKI, Kanagawa (JP); Yoshinori MACHIDA, Kanagawa (JP); Tadanobu SATO, Kanagawa (JP)

(73) Assignees: FUJIFILM CORPORATION, Tokyo (JP); FUJI XEROX CO., LTD., Tokyo (JP)

(21) Appl. No.: 13/718,509

(22) Filed: Dec. 18, 2012

(30) Foreign Application Priority Data
Feb. 27, 2012 (JP) 2012-040367

(51) Int. Cl. G02F 1/167

(52) U.S. Cl. CPC G02F 1/167
USPC 359/296; 252/500

(57) ABSTRACT

There is provided an electrophoretic particle, which contains a colored particle containing a charged group-containing polymer and a coloring agent, and a branched silicone-based polymer being attached to the colored particle and containing, as copolymerization components, a reactive monomer and at least one monomer selected from specific monomers, and a particle dispersion liquid for display, a display medium and a display device.

### CROSS-REFERENCE TO RELATED APPLICATIONS

This application is based on and claims priority under 35 USC 119 from Japanese Patent Application No. 2012-040367 filed on Feb. 27, 2012.

### BACKGROUND

1. Field

The present invention relates to an electrophoretic particle, a particle dispersion liquid for display, a display medium and a display device.

2. Description of the Related Art

As a display medium repeatedly rewritable thereon, an electrophoretic display medium is known. This display medium is constructed including, for example, a pair of substrates and an electrophoretic particle enclosed between the substrates in a manner capable of moving between the substrates in accordance with an electric field formed between the pair of substrates.

In this display medium, an electrophoretic particle and a particle dispersion liquid for display containing the electrophoretic particle are important factors, and various techniques have been proposed so as to maintain the dispersion stability of the electrophoretic particle in the particle dispersion liquid for display (see, for example, JP-A-2009-186808 (the term “JP-A” as used herein means an “unexamined published Japanese patent application”), JP-A-2010-244069, JP-A-03-249736, JP-A-2009-086135 and JP-A-2011-027781).

### SUMMARY

<1> An electrophoretic particle, containing:

a colored particle containing a charged group-containing polymer and a coloring agent, and

a branched silicone-based polymer being attached to said colored particle and containing, as copolymerization components, a reactive monomer and at least one monomer selected from a monomer represented by the following formula (I), a monomer represented by the following formula (II) and a monomer represented by the following formula (III):

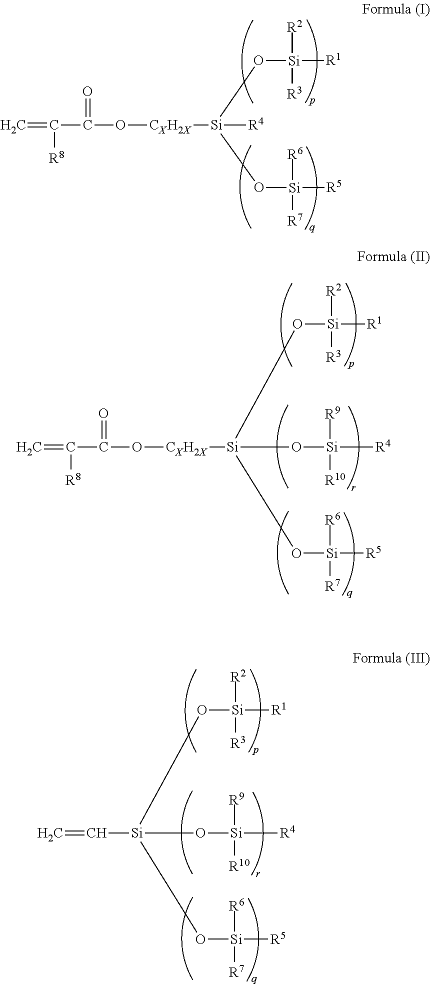

wherein in formula (I), formula (II) and formula (III), each of R¹, R², R³, R⁴, R⁵, R⁶, R⁷, R⁹ and R¹⁰ independently represents a hydrogen atom, an alkyl group having a carbon number of 1 to 4, or a fluoroalkyl group having a carbon number of 1 to 4,

R⁸ represents a hydrogen atom or a methyl group,

each of p, q and r independently represents an integer of 1 to 1,000, and

x represents an integer of 1 to 3.

### BRIEF DESCRIPTION OF THE DRAWINGS

FIG. 1 is a schematic configuration view of a display derive according to an exemplary embodiment,

FIG. 2 is a diagrammatic view schematically showing the relationship between the voltage applied and the migration amount (display density) of particle.

FIG. 3 is an explanatory view schematically showing the relationship between the voltage mode applied between substrates of the display medium and the migration mode of the particle,

wherein

10 denotes Display device, 12 denotes Display medium, 16 denotes Voltage applying part, 18 denotes Control part, 20 denotes Display substrate, 22 denotes Back surface substrate, 24 denotes Spacing member, 34 denotes Particle group, 34M denotes Magenta particle group, 34C denotes Cyan particle group, 34Y denotes Yellow particle group, 36 denotes Insulating particle, 38 denotes Supporting substrate, 40 denotes Surface electrode, 42 denotes Surface layer, 44 denotes Supporting substrate, 46 denotes Back surface electrode, 48 denotes Surface layer, and 50 denotes Dispersion medium.

### DETAILED DESCRIPTION

In the description of the present invention, the term “(meth)acryl” means both of “acryl and methacryl”, and the term “(meth)acrylate” means both of “acrylate and methacrylate”.

### <Electrophoretic Particle>

The electrophoretic particle according to this exemplary embodiment is configured to include:

a colored particle containing a charged group-containing polymer and a coloring agent, and

a branched silicone-based polymer being attached to the colored particle and containing, as copolymerization components, a reactive monomer and at least one monomer selected from a monomer represented by formula (I), a monomer represented by formula (II) and a monomer represented by formula (III).

That is, the electrophoretic particle according to this exemplary embodiment is an electrophoretic particle having a configuration where the above-described branched silicone-based polymer is attached to the above-described colored particle.

The electrophoretic particle according to this exemplary embodiment is a display particle capable of moving in accordance with an electric field, and this particle exhibits charging characteristics in a state of being dispersed in a dispersion medium and moves in the dispersion medium in accordance with an electric field formed.

Because the above-described branched silicone-based polymer is attached to the above-described colored particle, the electrophoretic particle according to this exemplary embodiment, in a state of being dispersed together with another electrophoretic particle having a small particle diameter, is kept from adhering to the another electrophoretic particle even when the amount of the polymer attached to the colored particle is small, as compared with an electrophoretic particle having a configuration where a linear silicone-based polymer or a branched silicone-based polymer having no reactive copolymerization component is attached to the colored particle.

The reasons therefor are not clearly known but are presumed as follows.

Conventionally, in order to maintain the dispersion stability of an electrophoretic particle in a particle dispersion liquid for display, an electrophoretic particle having a configuration where a polymer is attached to the surface of a colored particle, has been developed.

However, in a particle dispersion liquid for display containing a plurality of kinds of electrophoretic particles differing in the particle diameter, when the display medium is repeatedly driven and migration of an electrophoretic particle is repeated, an electrophoretic particle having a large particle diameter sometimes adheres to an electrophoretic particle having a small particle diameter. In particular, when a polymer constituting an electrophoretic particle having a large particle size is attached in a smaller amount, adherence between an electrophoretic particle having a large particle diameter and an electrophoretic particle having a small particle diameter tends to be more likely to occur.

In the electrophoretic particle according to this exemplary embodiment, the polymer attached to the colored particle contains at least one monomer represented by formulae (I) to (III) as a copolymerization component and therefore, has, as a side chain extending from the main chain (the framework to which a polymerization component is connected), a side chain (sometimes referred to as “branched silicone side chain”) where a siloxane bond diverges into a plurality of branches from a silicon atom closest to the main chain.

This branched silicone side chain is considered to densely cover the colored particle as compared with, for example, a side chain (sometimes referred to as “linear silicone side chain”) where one siloxane bond extends from a silicone atom closest to the main chain. For this reason, the electrophoretic particle according to this exemplary embodiment is estimated to be kept from adhering to another electrophoretic particle having a small particle diameter in a dispersion liquid even when the amount of the polymer attached to the colored particle is small, as compared with an electrophoretic particle having a configuration where a linear silicone-based polymer (a silicone-based polymer having a linear silicone side chain and having no branched silicone side chain) is attached to the colored particle.

Also, in the electrophoretic particle according to this exemplary embodiment, the branched silicone-based polymer attached to the colored particle contains a reactive monomer as a copolymerization component (a copolymerization component derived from the reactive monomer is sometimes referred to as “reactive copolymerization component”) and, for example, through a polymerization reaction by a reactive group of the reactive copolymerization component, a branched silicone-based polymer is bonded and attached to the surface of a colored particle.

For this reason, in the electrophoretic particle according to this exemplary embodiment, the polymer is considered to densely cover the colored particle as compared with a case where a branched silicone-based polymer having no reactive copolymerization component is attached to the surface of a colored particle, for example, by an interaction between an acid and a base.

As a result, the electrophoretic particle according to this exemplary embodiment is estimated to be kept from adhering to another electrophoretic particle having a small particle diameter in a dispersion liquid even when the amount of the polymer attached to the colored particle is small, as compared with an electrophoretic particle having a configuration where a branched silicone-based polymer having no reactive copolymerization component is attached to the colored particle.

Constituent elements constituting the electrophoretic particle according to this exemplary embodiment and raw material components contained in the constituent elements are described below.

### (Colored Particle)

The colored particle is configured to contain a charged group-containing polymer, a coloring agent and, if desired, other components. The colored particle may be a particle composed of a charged group-containing polymer having dispersed/blended therein a coloring agent, or a particle obtained by coating the coloring agent particle surface with a charged group-containing polymer.

The charged group-containing polymer is a polymer having, for example, a cationic group or an anionic group as the charged group. The cationic group as the charged group include, for example, an amino group and a quaternary ammonium group (including salts of these groups), and this cationic group imparts a positive charge polarity to the particle. The anionic group as the charged group includes, for example, a phenol group, a carboxy group, a carboxylate group, a sulfonic acid group, a sulfonate group, a phosphoric acid group, a phosphate group, and a tetraphenylboron group, and this anionic group imparts a negative charge polarity to the particle.

The charged group-containing polymer includes, for example, a homopolymer of a charged group-containing monomer, and a copolymer of a charged group-containing monomer and another monomer (a charged group-free monomer).

The charged group-containing monomer includes a cationic group-containing monomer (sometimes referred to as “cationic monomer”) and an anionic group-containing monomer (sometimes referred to as “anionic monomer”).

The cationic monomer includes, for example, the following monomers. Specific examples of the monomer include (meth)acrylates having an aliphatic amino group, such as N,N-dimethylaminoethyl (meth)acrylate, N,N-diethylaminoethyl (meth)acrylate, N,N-dibutylaminoethyl (meth)acrylate, N,N-hydroxyethylaminoethyl (meth)acrylate, N-ethylaminoethyl (meth)acrylate, N-octyl-N-ethylaminoethyl (meth)acrylate and N,N-dihexylaminoethyl (meth)acrylate; aromatic-substituted ethylene-based monomers having a nitrogen-containing group, such as dimethylaminostyrene, diethylaminostyrene, dimethylaminomethylstyrene and dioctylaminostyrene; nitrogen-containing vinyl ether monomers such as vinyl-N-ethyl-N-phenylaminoethyl ether, vinyl-N-butyl-N-phenylaminoethyl ether, triethanolamine divinyl ether, vinyl diphenyl aminoethyl ether, N-vinyl hydroxyethyl benzamide and m-aminophenyl vinyl ether; vinylamine; pyrroles such as N-vinylpyrrole; pyrrolines such as N-vinyl-2-pyrroline and N-vinyl-3-pyrroline; pyrrolidines such as N-vinylpyrrolidine, vinylpyrrolidine amino ether and N-vinyl-2-pyrrolidone; imidazoles such as N-vinyl-2-methyl imidazole; imidazolines such as N-vinylimidazoline; indoles such as N-vinylindole; indolines such as N-vinylindoline; carbazoles such as N-vinylcarbazole and 3,6-dibromo-N-vinylcarbazole; pyridines such as 2-vinylpyridine, 4-vinylpyridine and 2-methyl-5-vinylpyridine; piperidines such as (meth)acrylpiperidine, N-vinylpiperidone and N-vinylpiperazine; quinolines such as 2-vinylquinoline and 4-vinylquinoline; pyrazoles such as N-vinylpyrazole and N-vinylpyrazoline; oxazoles such as 2-vinyloxazole; and oxazines such as 4-vinyloxazine and morpholinoethyl (meth)acrylate.

In view of general versatility, (meth)acrylates having an aliphatic amino group, such as N,N-dimethylaminoethyl (meth)acrylate and N,N-diethylaminoethyl (meth)acrylate are preferred, and above all, the monomer is preferably used by forming a quaternary ammonium salt structure before or after polymerization. Formation into a quaternary ammonium salt may be attained by reacting the compound above with alkyl halides or tosylic acid esters.

The anionic monomer includes, for example, the following monomers.

Specifically, out of the anionic monomers, examples of the carboxylic acid monomer include (meth)acrylic acid, crotonic acid, itaconic acid, maleic acid, fumaric acid, citraconic acid, an anhydride or monoalkyl ester thereof, and vinyl ethers having a carboxyl group, such as carboxyethyl vinyl ether and carboxypropyl vinyl ether.

Examples of the sulfonic acid monomer include styrenesulfonic acid, 2-acrylamide-2-methylpropanesulfonic acid, 3-sulfopropyl(meth)acrylic acid ester, bis-(3-sulfopropyl)-itaconic acid ester, and a salt thereof. Other examples include a sulfuric acid monoester of 2-hydroxyethyl(meth)acrylic acid, and a salt thereof.

Examples of the phosphoric acid monomer include vinyl phosphoric acid, vinyl phosphate, acid phosphoxyethyl (meth)acrylate, acid phosphoxypropyl (meth)acrylate, bis(methacryloxyethyl) phosphate, diphenyl-2-methacryloyloxyethyl phosphate, diphenyl-2-acryloyloxyethyl phosphate, dibutyl-2-methacryloyloxyethyl phosphate, dibutyl-2-acryloyloxyethyl phosphate, and dioctyl-2-(meth)acryloyloxyethyl phosphate.

The anionic monomer is preferably a monomer having a (meth)acrylic acid or a sulfonic acid, more preferably a monomer having an ammonium salt structure formed before or after polymerization. The ammonium salt is obtained by reacting the monomer with tertiary amines or quaternary ammonium hydroxides.

Other monomers include a non-ionic monomer (nonionic monomer), and examples thereof include (meth)acrylonitrile, (meth)acrylic acid alkyl ester, (meth)acrylamide, ethylene, propylene, butadiene, isoprene, isobutylene, an N-dialkyl-substituted (meth)acrylamide, styrene, vinyl carbazole, styrene derivative, polyethylene glycol mono(meth)acrylate, vinyl chloride, vinylidene chloride, isoprene, butadiene, vinylpyrrolidone, hydroxyethyl (meth)acrylate, and hydroxybutyl (meth)acrylate.

The copolymerization ratio between the charged group-containing monomer and another monomer is changed according to the desired charge amount of the particle. Usually, the copolymerization ratio between the charged group-containing monomer and another monomer is selected in a range of, as the molar ratio, from 1:100 to 100:0.

The weight average molecular weight of the polymer having a charged group is preferably from 1,000 to 1,000,000, more preferably from 10,000 to 200,000.

As the coloring agent, an organic or inorganic pigment, an oil-soluble dye, or the like can be used. Examples thereof include known coloring agents such as magnetic powder (e.g., magnetite, ferrite), carbon black, titanium oxide, magnesium oxide, zinc oxide, phthalocyanine copper-based cyan color material, azo-based yellow color material, azo-based magenta color material, quinacridone-based magenta color material, red color material, green color material and blue color material. Specific examples thereof include Aniline Blue, Calco Oil Blue, Chrome Yellow, Ultramarine Blue, DuPont Oil Red, Quinoline Yellow, Methylene Blue Chloride, Phthalocyanine Blue, Malachite Green Oxalate, Lamp Black, Rose Bengal, C.I. Pigment Red 48:1, C.I. Pigment Red 122, C.I. Pigment Red 57:1, C.I. Pigment Yellow 97, C.I. Pigment Blue 15:1, and C.I. Pigment Blue 15:3.

The blending amount of the coloring agent is preferably from 10 to 99 mass %, more preferably from 30 to 99 mass %, based on the polymer having a charged group.

Other components include, for example, a charge control agent and a magnetic material.

As the charge control agent, known charge control agents used in electrophotographic toner materials can be used, and examples thereof include cetylpyridyl chloride, a quaternary ammonium salt such as BONTRON P-51, BONTRON P-53, BONTRON E-84 and BONTRON E-81 (all produced by Orient Chemical Industries, Co., Ltd.), a salicylic acid-based metal complex, a phenolic condensate, a tetraphenyl-based compound, a metal oxide particle, and a metal oxide particle surface-treated with a coupling agent of various types.

As the magnetic material, an inorganic or organic magnetic material that is colored, if desired, is used. A transparent magnetic material, particularly, a transparent organic magnetic material, is preferred, because this does not inhibit color development of a coloring pigment and is smaller in the specific gravity than an inorganic magnetic material.

The colored magnetic powder includes, for example, a small diameter colored magnetic powder described in JP-A-2003-131420, and a magnetic powder having a magnetic particle working out to a core and a colored layer stacked on the magnetic particle surface is used. The colored layer may be formed by opaquely coloring the magnetic powder with a pigment or the like, and, for example, an optical interference film is preferably used. The optical interference film is a film obtained by forming an achromatic material such as SiO₂ and TiO₂ into a thin film having a thickness equivalent to the light wavelength, and this film wavelength-selectively reflects light due to optical interference in a thin film.

### (Branched Silicone-Based Polymer)

The branched silicone-based polymer is configured to contain, as copolymerization components, at least one monomer selected from a monomer represented by the following formula (I), a monomer represented by the following formula (II) and a monomer represented by the following formula (III) (these monomers are each sometimes referred to as “branched silicone chain monomer” or sometimes collectively referred to as “branched silicone chain monomer”), a reactive monomer, and, if desired, other monomers.

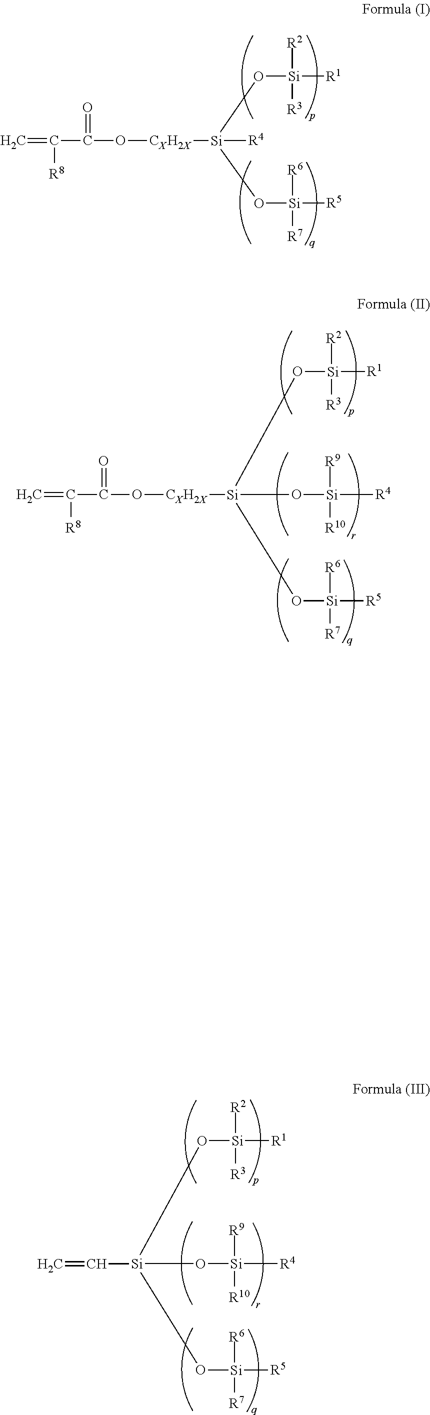

In formula (I), formula (II) and formula (III), each of R¹, R², R³, R⁴, R⁵, R⁶, R⁷, R⁹ and R¹⁰ independently represents a hydrogen atom, an alkyl group having a carbon number of 1 to 4, or a fluoroalkyl group having a carbon number of 1 to 4, R⁸ represents a hydrogen atom or a methyl group, each of p, q and r independently represents an integer of 1 to 1,000, and x represents an integer of 1 to 3.

As the branched silicone chain monomer represented by formulae (I) to (III), in view of polymerizability at the synthesis of a branched silicone-based polymer or from the standpoint of more successfully preventing adherence to another electrophoretic particle having a small particle diameter in a dispersion medium, the following embodiments are preferred.

Each of R¹, R⁴ and R⁵ is preferably an alkyl group having a carbon number of 1 to 4 (methyl group, ethyl group, n-propyl group, isopropyl group, n-butyl group, isobutyl group, sec-butyl group, tert-butyl group), more preferably a linear alkyl group having a carbon number of 1 to 4 (methyl group, ethyl group, n-propyl group, n-butyl group).

Each of R², R⁶ and R⁹ is preferably an alkyl group having a carbon number of 1 to 3 (methyl group, ethyl group, n-propyl group, isopropyl group), more preferably a linear alkyl group having a carbon number of 1 to 3 (methyl group, ethyl group, n-propyl group).

Each of R³, R⁷ and R¹⁰ is preferably an alkyl group having a carbon number of 1 to 3 (methyl group, ethyl group, n-propyl group, isopropyl group) or a fluoroalkyl group having a carbon number of 1 to 3, where all carbon atoms at the ends of an alkyl group having a carbon number of 1 to 3 (methyl group, ethyl group, n-propyl group, isopropyl group) are fluorinated, more preferably a linear alkyl group having a carbon number of 1 to 3 (methyl group, ethyl group, n-propyl group) or a fluoroalkyl group having a carbon number of 1 to 3, where all carbon atoms at the ends of a linear alkyl group having a carbon number of 1 to 3 (methyl group, ethyl group, n-propyl group) are fluorinated.

R⁸ is a hydrogen atom or a methyl group.

Each of p, q and r is independently preferably an integer of 1 to 5, more preferably an integer of 1 to 4.

x is preferably 2 or 3, more preferably 3.

As the monomer represented by formula (I), in view of polymerizability at the synthesis of a branched silicone-based polymer or from the standpoint of more successfully preventing adherence to another electrophoretic particle having a small particle diameter in a dispersion medium, the following embodiments are preferred.

Each of R¹ and R⁵ is preferably an alkyl group having a carbon number of 1 to 4 (methyl group, ethyl group, n-propyl group, isopropyl group, n-butyl group, isobutyl group, sec-butyl group, tert-butyl group), more preferably a linear alkyl group having a carbon number of 1 to 4 (methyl group, ethyl group, n-propyl group, n-butyl group).

Each of R² and R⁶ is preferably an alkyl group having a carbon number of 1 to 3 (methyl group, ethyl group, n-propyl group, isopropyl group), more preferably a linear alkyl group having a carbon number of 1 to 3 (methyl group, ethyl group, n-propyl group), still more preferably a methyl group or an ethyl group.

Each of R³ and R⁷ is preferably an alkyl group having a carbon number of 1 to 3 (methyl group, ethyl group, n-propyl group, isopropyl group) or a fluoroalkyl group having a carbon number of 1 to 3, where all carbon atoms at the ends of an alkyl group having a carbon number of 1 to 3 (methyl group, ethyl group, n-propyl group, isopropyl group) are fluorinated, more preferably a linear alkyl group having a carbon number of 1 to 3 (methyl group, ethyl group, n-propyl group) or a linear fluoroalkyl group having a carbon number of 1 to 3, where all carbon atoms at the ends of a linear alkyl group having a carbon number of 1 to 3 (methyl group, ethyl group, n-propyl group) are fluorinated.

R⁴ is preferably an alkyl group having a carbon number of 1 to 4 (methyl group, ethyl group, n-propyl group, isopropyl group, n-butyl group, isobutyl group, sec-butyl group, tert-butyl group), more preferably a linear alkyl group having a carbon number of 1 to 4 (methyl group, ethyl group, n-propyl group, n-butyl group), still more preferably a methyl group or an ethyl group.

R⁸ is a hydrogen atom or a methyl group and is preferably a methyl group.

Each of p and q is independently preferably an integer of 1 to 5, more preferably an integer of 2 to 4.

x is preferably 2 or 3, more preferably 3.

As the monomer represented by formula (II), in view of polymerizability at the synthesis of a branched silicone-based polymer or from the standpoint of more successfully preventing adherence to another electrophoretic particle having a small particle diameter in a dispersion medium, the following embodiments are preferred.

Each of R¹, R⁴ and R⁵ is preferably an alkyl group having a carbon number of 1 to 4 (methyl group, ethyl group, n-propyl group, isopropyl group, n-butyl group, isobutyl group, sec-butyl group, tert-butyl group), more preferably a linear alkyl group having a carbon number of 1 to 4 (methyl group, ethyl group, n-propyl group, n-butyl group), still more preferably a methyl group or an ethyl group.

Each of R², R⁶ and R⁹ is preferably an alkyl group having a carbon number of 1 to 3 (methyl group, ethyl group, n-propyl group, isopropyl group), more preferably a linear alkyl group having a carbon number of 1 to 3 (methyl group, ethyl group, n-propyl group), still more preferably a methyl group or an ethyl group.

Each of R³, R⁷ and R¹⁰ is preferably an alkyl group having a carbon number of 1 to 3 (methyl group, ethyl group, n-propyl group, isopropyl group), more preferably a linear alkyl group having a carbon number of 1 to 3 (methyl group, ethyl group, n-propyl group), still more preferably a methyl group or an ethyl group.

R⁸ is a hydrogen atom or a methyl group and is preferably a hydrogen atom.

Each of p, q and r is independently preferably an integer of 1 to 5, more preferably an integer of 1 to 3.

x is preferably 2 or 3, more preferably 3.

As the monomer represented by formula (III), in view of polymerizability at the synthesis of a branched silicone-based polymer or from the standpoint of more successfully preventing adherence to another electrophoretic particle having a small particle diameter in a dispersion medium, the following embodiments are preferred.

Each of R¹, R⁴ and R⁵ is preferably an alkyl group having a carbon number of 1 to 4 (methyl group, ethyl group, n-propyl group, isopropyl group, n-butyl group, isobutyl group, sec-butyl group, tert-butyl group), more preferably a linear alkyl group having a carbon number of 1 to 4 (methyl group, ethyl group, n-propyl group, n-butyl group), still more preferably a methyl group or an ethyl group.

Each of R², R⁶ and R⁹ is preferably an alkyl group having a carbon number of 1 to 3 (methyl group, ethyl group, n-propyl group, isopropyl group), more preferably a linear alkyl group having a carbon number of 1 to 3 (methyl group, ethyl group, n-propyl group), still more preferably a methyl group or an ethyl group.

Each of R³, R⁷ and R¹⁰ is preferably an alkyl group having a carbon number of 1 to 3 (methyl group, ethyl group, n-propyl group, isopropyl group), more preferably a linear alkyl group having a carbon number of 1 to 3 (methyl group, ethyl group, n-propyl group), still more preferably a methyl group or an ethyl group.

Each of p, q and r is independently preferably an integer of 1 to 5, more preferably an integer of 1 to 3.

Examples of the monomer represented by formula (I) include MCS-M11 and MFS-M15 produced by Gelest.

Examples of the monomer represented by formula (II) include RTT-1011 produced by Gelest.

Examples of the monomer represented by formula (III) include VTT-106 produced by Gelest.

Structural formulae of the monomers above are shown below.

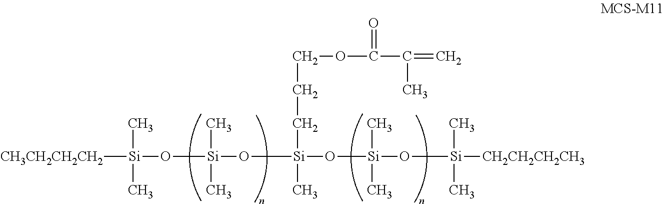

MCS-M11 is a compound where n in the structural formula above is an integer of 2 to 4 and the molecular weight is from 800 to 1,000.

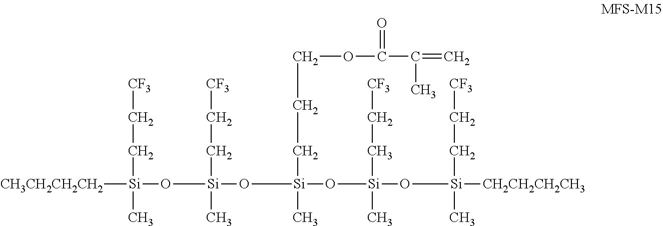

MFS-M15 is a compound represented by the structural formula above.

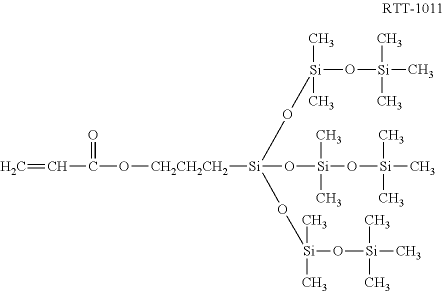

RTT-1011 is a compound represented by the structural formula above.

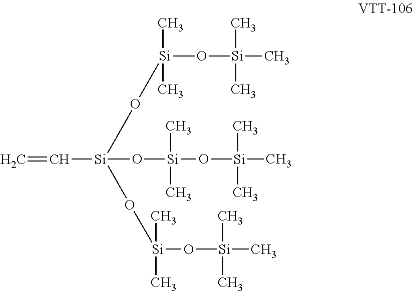 [SMILES: C=C[Si](O[Si](C)(C)O[Si](C)(C)C)(O[Si](C)(C)O[Si](C)(C)C)O[Si](C)(C)O[Si](C)(C)C]

VTT-106 is a compound represented by the structural formula above.

The reactive monomer includes, for example, a monomer having a reactive group such as epoxy group and isocyanate group. Specific examples thereof include a glycidyl (meth)acrylate (alias: (meth)acrylic acid glycidyl) and an isocyanate-based monomer (Karenz AOI and Karenz MOI, produced by Showa Denko K.K.).

Other monomers include a (meth)acrylic acid alkyl ester such as methyl (meth)acrylate, ethyl (meth)acrylate, propyl (meth)acrylate, butyl (meth)acrylate, hexyl (meth)acrylate, 2-ethylhexyl (meth)acrylate, dodecyl (meth)acrylate and stearyl (meth)acrylate, a hydroxyethyl (meth)acrylate, a hydroxybutyl (meth)acrylate, a monomer having an ethylene oxide unit, an alkyloxyoligoethylene glycol (meth)acrylate such as tetraethylene glycol monomethyl ether (meth)acrylate, a mono-terminated (meth)acrylate of polyethylene glycol, a (meth)acrylic acid, a maleic acid, and an N,N-dialkylamino(meth)acrylate.

Other monomers also include a linear silicone-based monomer. Specific examples of the linear silicone-based monomer include a dimethyl silicone compound having a (meth)acrylate group at one terminal (such as SILAPLANE FM-0711, SILAPLANE FM-0721 and SILAPLANE FM-0725, produced by Chisso Corp.; and X-22-174DX, X-22-2426 and X-22-2475, produced by Shin-Etsu Chemical Co., Ltd.).

The branched silicone-based polymer contains a branched silicone chain monomer and a reactive monomer as essential copolymerization components and contains, if desired, other monomers as a copolymerization component.

In the branched silicone-based polymer, from the standpoint of more successfully preventing adherence to another electrophoretic particle having a small particle diameter in a dispersion liquid, the copolymerization ratio of the branched silicone chain monomer is preferably 60 mass % or more, more preferably 80 mass % or more, still more preferably 90 mass % or more.

Also, the copolymerization ratio of the reactive monomer is preferably from 0.1 to 10 mass %. When the copolymerization ratio is 0.1 mass % or more, the branched silicone-based polymer is readily attached to the colored particle, and when it is 10 mass % or less, a reactive group is less likely to remain in the electrophoretic particle and aggregation of electrophoretic particles hardly occurs.

The weight average molecular weight of the branched silicone-based polymer is preferably from 1,000 to 1,000,000, more preferably from 10,000 to 1,000,000.

In the electrophoretic particle according to this exemplary embodiment, the amount of the branched silicone-based polymer attached (the mass of the branched silicone-based polymer based on the mass of the colored particle) is not particularly limited but is preferably from 0.01 to 100 mass %, more preferably from 0.1 to 50 mass %. When the amount attached is 0.01 mass % or more, adherence to another electrophoretic particle having a small particle diameter in a dispersion medium is more successfully prevented, and when it is 100 mass % or less, the charge amount of the colored particle is maintained and the electric field responsivity is improved.

The amount of the branched silicone-based polymer is calculated as an increase in the mass based on the colored particle, for example, by causing centrifugal sedimentation of the electrophoretic particle and measuring the mass of the particle. The amount attached can be also calculated from the composition analysis of the electrophoretic particle.

In the electrophoretic particle according to this exemplary embodiment, the ratio (coverage) of the surface covered with the branched silicone-based polymer based on the entire surface of the colored particle is not particularly limited. From the standpoint of more successfully preventing adherence to another electrophoretic particle having a small particle diameter in a dispersion medium, the coverage is preferably 10% or more, more preferably 30% or more, still more preferably 50% or more, yet still more preferably from 70 to 100%.

The coverage can be detected, for example, by an electron microscopy image.

As the method for producing the electrophoretic particle according to this exemplary embodiment, there may be employed, for example, a method of forming a colored particle by a known technique (e.g., coacervation, dispersion polymerization, suspension polymerization), dispersing the colored particle in a solvent containing a branched silicone-based polymer, and allowing the branched silicone-based polymer to undergo a reaction and be attached to the colored particle surface.

The technique for attaching the branched silicone-based polymer to the colored particle surface includes, for example, a technique of combining a reactive group (such as epoxy group) contained in the branched silicone-based polymer with a functional group (such as amino group or ammonium group) on the colored particle surface through a polymerization reaction caused therebetween by heating or the like.

### <Particle Dispersion Liquid for Display>

The particle dispersion liquid for display according to this exemplary embodiment is configured to contain a first particle group containing an electrophoretic particle, a second particle group containing an electrophoretic particle, and a dispersion medium for dispersing these particle groups therein.

The first particle group is composed of a first electrophoretic particle (sometimes referred to as “large-diameter electrophoretic particle”) containing a charged group-containing polymer, a colored particle containing a coloring agent, and a branched silicone-based polymer being attached to the colored particle and containing, as copolymerization components, a reactive monomer and at least one monomer selected from a monomer represented by formula (I), a monomer represented by formula (II) and a monomer represented by formula (III). That is, the first particle group is composed of the electrophoretic particle according to this exemplary embodiment.

The second particle group is composed of a second electrophoretic particle (sometimes referred to as “small-diameter electrophoretic particle”) taking on a color different from the first electrophoretic particle and having a smaller particle diameter than the first electrophoretic particle.

Thanks to this configuration, the particle dispersion liquid for display according to this exemplary embodiment is kept from adherence between the first electrophoretic particle and the second electrophoretic particle, as compared to when the first electrophoretic particle is an electrophoretic particle having a configuration where a linear silicone-based polymer or a branched silicon-based polymer having no reactive copolymerization component is attached to the colored particle.

Although the reason is not clearly known, even when out of two kinds of electrophoretic particle groups differing in the particle diameter, the particle group having a smaller particle diameter is composed of the electrophoretic particle according to this exemplary embodiment and the particle group having a larger particle diameter is composed of an electrophoretic particle other than the electrophoretic particle according to this exemplary embodiment, adherence between electrophoretic particles differing in the particle diameter is sometimes not prevented.

In the particle dispersion liquid for display according to this exemplary embodiment, out of two kinds of electrophoretic particle groups differing in the particle diameter, the particle group having a larger particle diameter must be composed of the electrophoretic particle according to this exemplary embodiment. The particle group having a smaller particle diameter may be composed of the electrophoretic particle according to this exemplary embodiment or may be composed of an electrophoretic particle other than the electrophoretic particle according to this exemplary embodiment.

In the particle dispersion liquid for display according to this exemplary embodiment, the first particle group may be further grouped into a plurality of kinds of groups by the color. Also, the second particle group may be further grouped into a plurality of kinds of groups by the color.

The particle dispersion liquid for display according to this exemplary embodiment may contain a particle group (hereinafter, sometimes referred to as “third particle group”) having a larger particle diameter than the first particle group and being composed of an electrophoretic particle other than the electrophoretic particle according to this exemplary embodiment.

This configuration is described below by referring to specific configuration examples.

The configuration above is described by referring to, for example, a case where the particle dispersion liquid for display according to this exemplary embodiment contains three kinds of electrophoretic particle groups differing in the color from each other (a magenta particle group M of magenta color, a cyan particle group C of cyan color, and a yellow particle group Y of yellow color) and the particle diameters of these particle groups become small in the order of magenta particle group M>cyan particle group C>yellow particle group Y. This case includes, for example, the following configuration examples.

(1) One configuration example is a configuration where the magenta particle group M is a particle group composed of the electrophoretic particle according to this exemplary embodiment and each of the cyan particle group C and the yellow particle group Y is a particle group composed of an electrophoretic particle other than the electrophoretic particle according to this exemplary embodiment.

In this configuration example, the magenta particle group M is the first particle group, and the cyan particle group C and the yellow particle group Y are the second particle group.

In this configuration example, adherence of electrophoretic particles is prevented between the magenta particle group M and the cyan particle group C and between the magenta particle group M and the yellow particle group Y.

(2) One configuration example is a configuration where each of the magenta particle group M and the yellow particle group Y is a particle group composed of the electrophoretic particle according to this exemplary embodiment and the cyan particle group C is a particle group composed of an electrophoretic particle other than the electrophoretic particle according to this exemplary embodiment.

In this configuration example, the magenta particle group M is the first particle group, and the cyan particle group C and the yellow particle group Y are the second particle group.

In this configuration example, adherence of electrophoretic particles is prevented between the magenta particle group M and the cyan particle group C and between the magenta particle group M and the yellow particle group Y.

(3) One configuration example is a configuration where each of the magenta particle group M and the cyan particle group C is a particle group composed of the electrophoretic particle according to this exemplary embodiment and the yellow particle group Y is a particle group composed of an electrophoretic particle other than the electrophoretic particle according to this exemplary embodiment.

In this configuration example, among the magenta particle group M, the cyan particle group C and the yellow particle group Y, the magenta particle group M is the first particle group, and the cyan particle group C and the yellow particle group Y are the second particle group. Also, of the cyan particle group C and the yellow particle group Y, the cyan particle group C is the first particle group and the yellow particle group Y is the second particle group.

In this configuration example, adherence of electrophoretic particles is prevented between the magenta particle group M and the cyan particle group C, between the magenta particle group M and the yellow particle group Y, and between the cyan particle group C and the yellow particle group Y.

(4) One configuration example is a configuration where each of the magenta particle group M, the cyan particle group C and the yellow particle group Y is a particle group composed of the electrophoretic particle according to this exemplary embodiment.

In this configuration example, among the magenta particle group M, the cyan particle group C and the yellow particle group Y, the magenta particle group M is the first particle group, and the cyan particle group C and the yellow particle group Y are the second particle group. Also, of the cyan particle group C and the yellow particle group Y, the cyan particle group C is the first particle group and the yellow particle group Y is the second particle group.

In this configuration example, adherence of electrophoretic particles is prevented between the magenta particle group M and the cyan particle group C, between the magenta particle group M and the yellow particle group Y, and between the cyan particle group C and the yellow particle group Y.

(5) One configuration example is a configuration where the cyan particle group C is a particle group composed of the electrophoretic particle according to this exemplary embodiment and each of the magenta particle group M and the yellow particle group Y is a particle group composed of an electrophoretic particle other than the electrophoretic particle according to this exemplary embodiment.

In this configuration example, the cyan particle group C is the first particle group, the yellow particle group Y is the second particle group, and the magenta particle group M is the third particle group.

In this configuration example, adherence of electrophoretic particles is prevented between the cyan particle group C and the yellow particle group Y.

(6) One configuration example is a configuration where each of the cyan particle group C and the yellow particle group Y is a particle group composed of the electrophoretic particle according to this exemplary embodiment and the magenta particle group M is a particle group composed of an electrophoretic particle other than the electrophoretic particle according to this exemplary embodiment.

In this configuration example, the cyan particle group C is the first particle group, the yellow particle group Y is the second particle group, and the magenta particle group M is the third particle group.

In this configuration example, adherence of electrophoretic particles is prevented between the cyan particle group C and the yellow particle group Y.

As described above, a third particle group may be contained in the particle dispersion liquid for display according to this exemplary embodiment but is preferably not contained. More specifically, when the electrophoretic particles contained in the particle dispersion liquid for display according to this exemplary embodiment are grouped by the color, the particle group having a maximum particle group is preferably the first particle group, that is, a particle group composed of the electrophoretic particle according to this exemplary embodiment.

The particle dispersion liquid for display according to this exemplary embodiment may contain, if desired, a particle group composed of a display particle (hereinafter sometimes referred to as “insulating particle”) that is low in the electric field responsivity for displaying the background color. In this case, the insulating particle group may have a larger or smaller particle diameter than the first particle group but in view of responsivity, preferably has a smaller particle diameter than the first particle group.

Incidentally, the particle diameters of the display particle and the particle group for display mean a volume average particle diameter and are a value measured by a particle diameter analyzer (FPAR-1000 manufactured by Otsuka Electronics, Co., Ltd. or LA300 manufactured by Horiba, Ltd.).

Constituent elements constituting the particle dispersion liquid for display according to this exemplary embodiment and raw material components contained in the constituent elements are described below.

### (Large-Diameter Electrophoretic Particle and Small-Diameter Electrophoretic Particle)

The large-diameter electrophoretic particle and the small-diameter electrophoretic particle are preferably combined, for example, such that the volume average particle diameter of the small-diameter electrophoretic particle is ⅕ or less, more preferably 1/10 or less, the volume average particle diameter of the large-diameter electrophoretic particle. With such a combination, the small-diameter electrophoretic particle can readily migrate through a gap of the large-diameter electrophoretic particle group.

The diameter of the large-diameter electrophoretic particle is not particularly limited but, for example, the volume average particle diameter is from 1 to 20 μm, preferably from 5 to 15 μm. The diameter of the small-diameter electrophoretic particle is not particularly limited but, for example, the volume average particle diameter is from 0.1 to 1 μm, preferably from 0.3 to 1 μm.

The large-diameter electrophoretic particle is the electrophoretic particle according to this exemplary embodiment, and constituent elements thereof and raw material components contained in the constituent elements are as described above.

The small-diameter electrophoretic particle is a particle capable of moving in accordance with an electric field, and this particle exhibits charging characteristics in a state of being dispersed in a dispersion medium and moves in the dispersion medium in accordance with an electric field formed.

The small-diameter electrophoretic particle is configured to contain, for example, a colored particle containing a charged group-containing polymer and a coloring agent and, if desired, contain a polymer attached to the surface of the colored particle.

As for the colored particle containing the charged group-containing polymer and the coloring agent, which are constituting the small-diameter electrophoretic particle, the configuration of the colored particle as a constituent element of the large-diameter electrophoretic particle and the raw material components as well as the production method of the large-diameter electrophoretic particle may be employed, but the color is different from that of the large-diameter electrophoretic particle.

The polymer attached to the surface of the colored particle includes, for example, the above-described branched silicone-based polymer, and a linear silicone-based polymer containing a linear silicone chain monomer and a reactive monomer as essential components and, if desired, containing other monomers as a copolymerization component. The reactive monomer and other monomers in the linear silicone-based polymer include the monomers used in the above-described branched silicone-based polymer, and the linear silicone chain monomer includes a dimethyl silicone monomer having a (meth)acrylate group at one terminal (for example, SILAPLANE FM-0711, SILAPLANE FM-0721 and SILAPLANE FM-0725, produced by Chisso Corp.; and X-22-174DX, X-22-2426 and X-22-2475, produced by Shin-Etsu Chemical Co., Ltd.).

As the small-diameter electrophoretic particle, an embodiment where the charged group-containing polymer or the polymer attached to the surface of the colored particle is a silicone-based polymer, is preferred. The silicone-based polymer may be configured to contain, as a copolymerization component, a dimethyl silicone monomer having a (meth)acrylate group at one terminal (for example, SILAPLANE FM-0711, SILAPLANE FM-0721 and SILAPLANE FM-0725, produced by Chisso Corp.; and X-22-174DX, X-22-2426 and X-22-2475, produced by Shin-Etsu Chemical Co., Ltd.).

### (Dispersion Medium)

As the dispersion medium, various dispersion mediums used for a display medium may be applied, but a low-dielectric solvent (for example, having a dielectric constant of 5.0 or less, preferably 3.0 or less) is preferably selected. A solvent other than a low-dielectric solvent may be used in combination, but the dispersion medium preferably contains 50 vol % or more of a low-dielectric solvent. Incidentally, the dielectric constant of the low-dielectric solvent is determined using a dielectric meter (manufactured by Nihon Rufuto Co., Ltd.).

The low-dielectric solvent includes, for example, a paraffin-based hydrocarbon solvent, a silicone oil, and a petroleum-derived high boiling solvent such as fluorine-based liquid, but it is preferred to select a silicone oil as the dispersion medium according to the branched silicone-based polymer that is a constituent element of the large-diameter electrophoretic particle. Of course, this exemplary embodiment is not limited thereto.

The silicone oil specifically includes a silicon oil in which a hydrocarbon group is bonded to the siloxane bond (for example, dimethyl silicone oil, diethyl silicone oil, methylethyl silicone oil, methylphenyl silicone oil and diphenyl silicone oil). Among these, dimethyl silicone oil is particularly preferred.

The paraffin-based hydrocarbon solvent includes a normal paraffin-based hydrocarbon having a carbon number of 20 or more (boiling point: 80° C. or more) and an isoparaffin-based hydrocarbon, and for the reasons of safety, volatility and the like, an isoparaffin-based hydrocarbons is preferably used. Specific examples thereof include SHELLSOL 71 (produced by Showa Shell Sekiyu K.K.), ISOPAR O, ISOPAR H, ISOPAR K, ISOPAR L, ISOPAR G, ISOPAR M (ISOPAR is a trade name of Exxon Mobile Corp.), and IP SOLVENT (produced by Idemitsu Petro-Chemical Co., Ltd.).

### (Other Components)

The particle dispersion liquid for display according to this exemplary embodiment may be configured to contain, if desired, an acid, an alkali, a salt, a dispersant, a dispersion stabilizer, a stabilizer for the purpose of, for example, oxidization prevention or ultraviolet absorption, an antibacterial agent, an antiseptic, a charge control agent, and the like.

Examples of the charge control agent include an ionic or nonionic surfactant, block or graft copolymers consisting of a lipophilic moiety and a hydrophilic moiety, a compound having a polymer chain framework, such as cyclic, star-like or tree-like polymer (dendrimer), a metal complex of salicylic acid, a metal complex of catechol, a metal-containing bis-azo dye, a tetraphenyl borate derivative, and a copolymer of a polymerizable silicone macromer (SILAPLANE, produced by Chisso Corp.) and an anionic or cationic monomer.

More specifically, the ionic or nonionic surfactant include the followings. Examples of the nonionic surfactant include a polyoxyethylene nonylphenyl ether, a polyoxyethylene octylphenyl ether, a polyoxyethylene dodecylphenyl ether, a polyoxyethylene alkyl ether, a polyoxyethylene fatty acid ester, a sorbitan fatty acid ester, a polyoxyethylene sorbitan fatty acid ester, and a fatty acid alkylol amide. Examples of the anionic surfactant include an alkylbenzene sulfonate, an alkylphenyl sulfonate, an alkylnaphthalene sulfonate, a higher fatty acid salt, a sulfuric ester salt of a higher fatty acid ester, and a sulfonic acid of a higher fatty acid ester. Examples of the cationic surfactant include a primary to tertiary amine salt and a quaternary ammonium salt.

The charge control agent is preferably used in an amount of 0.01 to 20 mass %, more preferably from 0.05 to 10 mass %, based on the solid content of the display particle.

The electrophoretic particle and the particle dispersion liquid for display according to this exemplary embodiment are used for an electrophoretic display medium and the like.

### <Display Medium, Display Device>

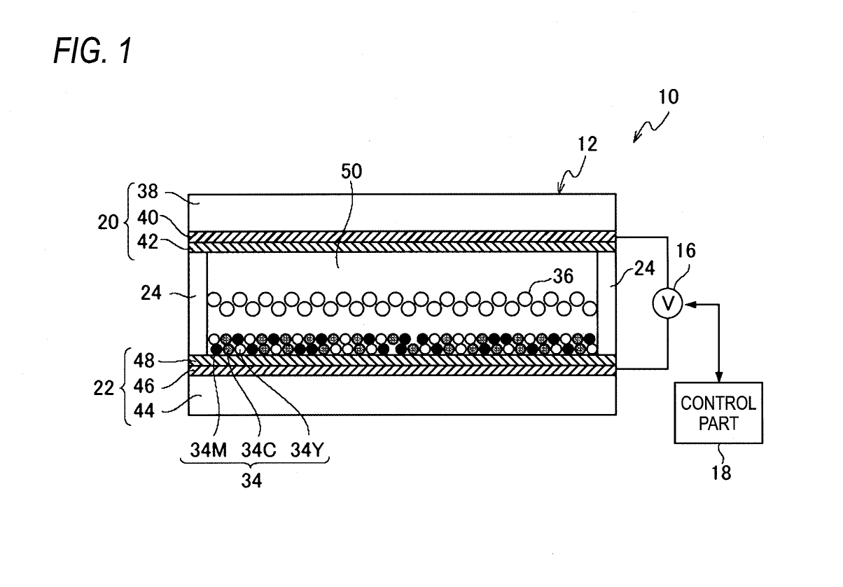

FIG. 1 is one example of the schematic configuration view showing the display device according to this exemplary embodiment. Incidentally, the display device according to this exemplary embodiment is not limited to the configuration described below.

The display device 10 according to this exemplary embodiment is in the mode where the particle dispersion liquid for display according to this exemplary embodiment is applied as the particle dispersion liquid of a display medium 12, containing a dispersion medium 50 and a particle group 34.

As shown in FIG. 1, the display device 10 according to this exemplary embodiment is configured to include a display medium 12, a voltage applying part 16, and a control part 18. The control part 18 is connected to the voltage applying part 16 to allow signal communication therebetween.

The control part 18 is constructed as a microcomputer including CPU (central processing unit) for governing the operation of the entire device, RAM (Random Access Memory) for temporarily storing various data, and ROM (Read Only Memory) in which various programs including a control program for controlling the entire device and a program determined by the processing routine are previously stored.

Incidentally, the display medium 12 corresponds to the display medium of the present invention, the display device 10 corresponds to the display device of the present invention, and the voltage applying part 16 corresponds to the voltage applying unit of the display device of the present invention.

The voltage applying part 16 is electrically connected to a front electrode 40 and a rear electrode 46. In the mode of this exemplary embodiment, a case where both a front electrode 40 and a rear electrode 46 are electrically connected to a voltage applying 16 is described, but there may be also employed a mode where one of the front electrode 40 and the rear electrode 46 is connected to ground and another is connected to the voltage applying part 16.

The voltage applying part 16 is a voltage applying device for applying a voltage to the front electrode 40 and the rear electrode 46 and applies a voltage between the front electrode 40 and the rear electrode 46 in accordance with the control of the control part 18.

The display medium 12 is described in detail below.

As shown in FIG. 1, the display medium 12 is configured to include a display substrate 20 serving as a display surface, a back surface substrate 22 facing the display substrate 20 with spacing, a spacing member 24 for maintaining a predetermined gap between these substrates and at the same time, partitioning the gap between the display substrate 20 and the back surface substrate 22 into a plurality of cells, and a particle group 34 enclosed in each cell.

The cell indicates a region surrounded by the display substrate 20, the back surface substrate 22 and the spacing member 24. In this cell, a dispersion medium 50 is enclosed. The particle group 34 is dispersed in the dispersion medium 50 and moves between the display substrate 20 and the back surface substrate 22 in accordance with the intensity of an electric field formed in the cell.

Incidentally, the display medium 12 may be also configured for providing a spacing member 24 therein to correspond to respective pixels on displaying an image and form cells corresponding to respective pixels, so that the display medium 12 can display a color for each pixel.

Furthermore, other than shown in FIG. 1, the cell may be formed by holding a capsule having encapsulated therein a dispersion medium in the substrate. In this case, the substrate need not be a pair of substrates and may be a single substrate.

In the dispersion medium 50 of the display medium 12, a plurality of kinds of particle groups 34 differing in the color from each other are dispersed. The plurality of kinds of particle groups 34 are a particle capable of electrophoretically migrating between substrates, and the absolute value of the voltage necessary for inducing movement in accordance with an electric field differs among particle groups of respective colors.

For example, the configuration is described on the assumption that as shown in FIG. 1, particle groups 34 of three colors, that is, a magenta particle group 34M of magenta color, a cyan particle group 34C of cyan color and a yellow particle group 34Y of yellow color, are enclosed as the particle group 34 enclosed in the same cell of the display medium 12 and the particle diameters become small in the order of magenta particle group 34M>cyan particle group 34C>yellow particle group 34Y.

One configuration example is a configuration where the magenta particle group M is the first particle group, and the cyan particle group C and the yellow particle group Y are the second particle group.

One configuration example is a configuration where while the magenta particle group M is the first particle group, the cyan particle group C and the yellow particle group Y are the second particle group relative to the magenta particle group M, and furthermore, while the cyan particle group C is the first particle group, the yellow particle group Y is the second particle group relative to the cyan particle group C.

One configuration example is a configuration where the cyan particle group C is the first particle group, the yellow particle group Y is the second particle group, and the magenta particle group M is the third particle group.

Particles in the plurality of kinds of particle groups 34 differing in the absolute value of the voltage necessary for inducing movement in accordance with an electric field are obtained, for example, by changing the kind of the “ionic polymer” in the production method of the particle dispersion liquid according to the exemplary embodiment above to produce particle dispersion liquids each containing particles differing in the charge amount, and mixing the particle dispersion liquids.

The content (mass %) of the particle group 34 based on the entire mass in the cell is not particularly limited as long as the concentration is high enough to obtain a desired color phase, and it is effective as the display medium 12 to adjust the content according to the thickness of the cell. That is, in order to obtain a desired color phase, the content may be small when the cell is thick, and the content may be large when the cell is thin. In general, the content is from 0.01 to 50 mass %.

Respective constituent members of the display medium 12 are described below.

The display substrate 20 has a configuration where a front electrode 40 and a surface layer 42 are stacked in order on a supporting substrate 38. The back surface substrate 22 has a configuration where a rear electrode 46 and a surface layer 48 are stacked in order on a supporting substrate 44.

Examples of the material for the supporting substrate 38 and the supporting substrate 44 include glass and plastics such as polycarbonate resin, acrylic resin, polyimide resin, polyester resin, epoxy resin and polyethersulfone resin.

Examples of the material which can be used for the rear electrode 46 and the front electrode 40 include an oxide of indium, tin, cadmium, antimony or the like, a composite oxide such as ITO, a metal such as gold, silver, copper and nickel, and an organic electrically conductive material such as polypyrrole and polythiophene. Such a material may be used as a single-layer film, a mixed film or a composite film, and the film is formed by a vapor deposition method, a sputtering method, a coating method or the like. The thickness of the film is, in the case of a vapor deposition method and a sputtering method, usually from 100 to 2,000 angstroms. Each of the rear electrode 46 and the front electrode 40 is formed in a desired pattern, for example, in a matrix pattern or a striped pattern enabling passive matrix driving, by a conventionally known technique such as etching for existing liquid crystal devices or printed circuit boards.

Also, the front electrode 40 may be embedded in the supporting substrate 38. Similarly, the rear electrode 46 may be embedded in the supporting substrate 44. In this case, the material for the supporting substrate 38 or the supporting substrate 44 may affect the charging characteristics or fluidity of each particle of the particle group 34 and therefore, is selected according to the composition or the like of each particle of the particle group 34.

Incidentally, each of the rear electrode 46 and the front electrode 40 may be separated from the display substrate 20 or the back surface substrate 22 and disposed outside the display medium 12. In this case, because of a configuration where the display medium 12 is sandwiched between the rear electrode 46 and the front electrode 40, the distance between electrodes of the rear electrode 46 and the front electrode 40 becomes large, leading to reduction in the electric field intensity, and therefore, it is necessary to take a measure, for example, reduce the thickness of each of the supporting substrate 38 and the supporting substrate 44 of the display medium 12 or reduce the distance between substrates of the supporting substrate 38 and the supporting substrate 44, so that a desired electric field intensity can be obtained.

Although both the display substrate 20 and the back surface substrate 22 are provided with an electrode (front electrode 40 and rear electrode 46) in the description above, it is also possible to provide an electrode to either one substrate.

In order to enable active matrix driving, each of the supporting substrate 38 and the supporting substrate 44 may be provided with TFT (thin film transistor) at each pixel. The TFT is preferably formed not on the display substrate but on the back surface substrate 22, because lamination of wiring and mounting of components are easy.

Here, when the display medium 12 is driven by simple matrix driving, the configuration of the later-described display device 10 provided with the display medium 12 can be a simple configuration, and when driven by active matrix driving using TFT, the display speed is high as compared with simple matrix driving

In the case where the front electrode 40 and the rear electrode 46 are formed on the supporting substrate 38 and the supporting substrate 44, respectively, a surface layer 42 and/or a surface layer 48, which are a dielectric film, are preferably formed, if desired, on the front electrode 40 and the rear electrode 46, respectively, so as to keep the front electrode 40 and the rear electrode 46 from breakage or prevent electric leakage from occurring between electrodes to incur adherence of particles of the particle group 34.

Examples of the material which may be used to form the surface layer 42 and/or the surface layer 48 include polycarbonate, polyester, polystyrene, polyimide, epoxy, polyisocyanate, polyamide, polyvinyl alcohol, polybutadiene, polymethyl methacrylate, copolymer nylon, ultraviolet-curing acrylic resin, and fluororesin.

Other than the above-described insulating materials, a material obtained by incorporating a charge transport substance into an insulating material may be also used. Incorporation of a charge transport substance produces an effect of, for example, increasing the particle chargeability upon injection of a charge into the particles or stabilizing the charge amount of the particle by leaking the charge of the particle when the charge amount of the particle becomes excessively large.

Examples of the charge transport substance include a hydrazone compound, a stilbene compound, a pyrazoline compound, and an arylamine compound, which are a hole transport substance. Also, a fluorenone compound, a diphenoquinone derivative, a pyrane compound, a zinc oxide, and the like, which are an electron transport substance, may be used. Furthermore, a self-supporting resin having a charge transporting property may be used.

Specific examples thereof include polyvinylcarbazole, and polycarbonate obtained by polymerization of a specific dihydroxyarylamine and bischloroformate described in U.S. Pat. No. 4,806,443. The dielectric film may sometimes affect the charging characteristics or fluidity of the particle and therefore, is selected according to the composition or the like of the particle. Because the display substrate as one of the substrates must transmit light, out of the above-described materials, transparent materials are preferably used.

The spacing member 24 for maintaining the gap between the display substrate 20 and the back surface substrate 22 is formed not to impair the transparency of the display substrate 20 and is formed of, for example, a thermoplastic resin, a thermosetting resin, an electron beam-curable resin, a photo-curable resin, rubber, or a metal.

The spacing member 24 includes a cellular member and a particulate member. The cellular member includes, for example, a net. The net is easily available, inexpensive and relatively uniform in the thickness and therefore, is useful when producing an inexpensive display medium 12. The net is unsuited to displaying a fine image and is preferably used for a large display device not requiring high resolution. Other examples of the cellular spacing member 24 include a sheet that is perforated in a matrix pattern by etching, laser processing or the like. The thickness, hole shape, hole size and the like of this sheet are easily adjusted as compared with the net. For this reason, the sheet is used in a display medium for displaying a fine image and is effective in more enhancing the contrast.

The spacing member 24 may be integrated with either one of the display substrate 20 and the back surface substrate 22, and the supporting substrate 38 or the supporting substrate 44 is subjected to etching, laser processing, press forming using a mold produced in advance, printing, or the like, whereby the supporting substrate 38 or the supporting substrate 44, having a cell pattern with an arbitrary size, and the spacing member 24 are produced.

In this case, the spacing member 24 may be formed on either one or both of the display substrate 20 side and the back surface substrate 22 side.

The spacing member 24 may be colored or colorless but is preferably colorless and transparent so as not to adversely affect the display image displayed on the display medium 12. In this case, for example, a transparent resin such as polystyrene, polyester and acryl may be used.

The particulate spacing member 24 is preferably transparent, and a glass particle as well as a transparent resin particle such as polystyrene, polyester and acryl are used.

In the display medium 12, an insulating particle 36 is enclosed in each cell. The insulating particle 36 is a particle differing in the color from the particle group 34 enclosed in the same cell and being insulating.

The insulating particles 36 are floating in the dispersion medium 50, with a spacing large enough to allow for passing of each of respective particles of the particle groups 34. Alternatively, the insulating particles 36 are arranged along the direction substantially orthogonal to the opposing direction of the back surface substrate 22 and the display substrate 20, with a spacing large enough to allow for passing of each of respective particles of the particle groups 34.

A gap large to such an extent that respective particles of the particle groups 34 contained in the same cell can be stacked in a plurality of layers in the opposing direction of the back surface substrate 22 and the display substrate 20, is provided between the insulating particle 36 and the back surface substrate 22 and between the display substrate 20 and the insulating particle 36.

Each particle of the particle group 34 passes through a gap between the insulating particles 36 and moves from the back surface substrate 22 side to the display substrate 20 side or from the display substrate 20 side to the back surface substrate 22 side. As the color of the insulating particle 36, for example, a white or a black color is preferably selected to serve as a background color.

Examples of the insulating particle 36 include a spherical particle of benzoguanamine-formaldehyde condensate, a spherical particle of benzoguanamine-melamine-formaldehyde condensate, a spherical particle of melamine-formaldehyde condensate (EPOSTAR, produced by Nippon Shokubai Co., Ltd.), a spherical particle of titanium oxide-containing crosslinked polymethyl methacrylate (MBX-WHITE, produced by Sekisui Plastics Co., Ltd.), a spherical particle of crosslinked polymethyl methacrylate (CHEMISNOW MX, produced by Soken Chemical & Engineering Co., Ltd.), a polytetrafluoroethylene particle (LUBRON L, produced by Daikin Industries, Ltd., and SST-2, produced by Shamrock Technologies Inc.), a carbon fluoride particle (CF-100, produced by Nippon Carbon Co., Ltd., and CFGL and CFGM, both produced by Daikin Industries, Ltd.), a silicone resin particle (TOSPEARL, produced by Toshiba Silicone K.K.), a titanium oxide-containing polyester particle (BIRYUSHIA PL 1000 WHITE T, produced by Nippon Paint Co., Ltd.), a titanium oxide-containing polyester-acrylic particle (KONAC No. 181000 WHITE, produced by NOF Corp.), and a spherical particle of silica (HIPRESICA, produced by UBE-NITTO KASEI Co., Ltd.). The insulating particle is not limited to those described above and may be a particle obtained by mixing/dispersing a white pigment such as titanium oxide in a resin, and then pulverizing and classifying the dispersion into a desired particle diameter.

The insulating particle 36 is provided between the display substrate 20 and the back surface substrate 22 as described above and therefore, preferably has a volume average primary particle diameter of ⅕ to 1/100 the length of the opposing direction between the display substrate 20 and the back surface substrate 22 of the cell, and the content thereof is preferably from 1 to 50 vol % based on the volume of the cell.

The size of the cell in the display medium 12 is closely related to the resolution of the display medium 12, and as the cell is smaller, a display medium having higher resolution can be fabricated. Usually, the size of the cell is approximately from 10 μm to 1 mm.

For fixing the display substrate 20 and the back surface substrate 22, a combination of a bolt and a nut, or a fixing device such as clamp, clip and frame for fixing substrate, may be used. Also, a fixing technique such as adhesive, thermal fusion and ultrasonic bonding may be used.

The display medium 12 can be used, for example, in a bulletin board, a circular notice, an electronic blackboard, an advertising display, a signboard, a blinking indicator, an electronic paper, an electronic newspaper, an electronic book, and a document sheet for common use with a copier/a printer, on each of which an image can be stored and rewritten.

The display medium 12 displays different colors by changing the applied voltage (V) applied between the display substrate 20 and the back surface substrate 22.

In the display medium 12, the particle moves in accordance with an electric field formed between the display substrate 20 and the back surface substrate 22, whereby colors according to respective pixels of the image data can be displayed for each cell corresponding to each pixel of the display medium 12.

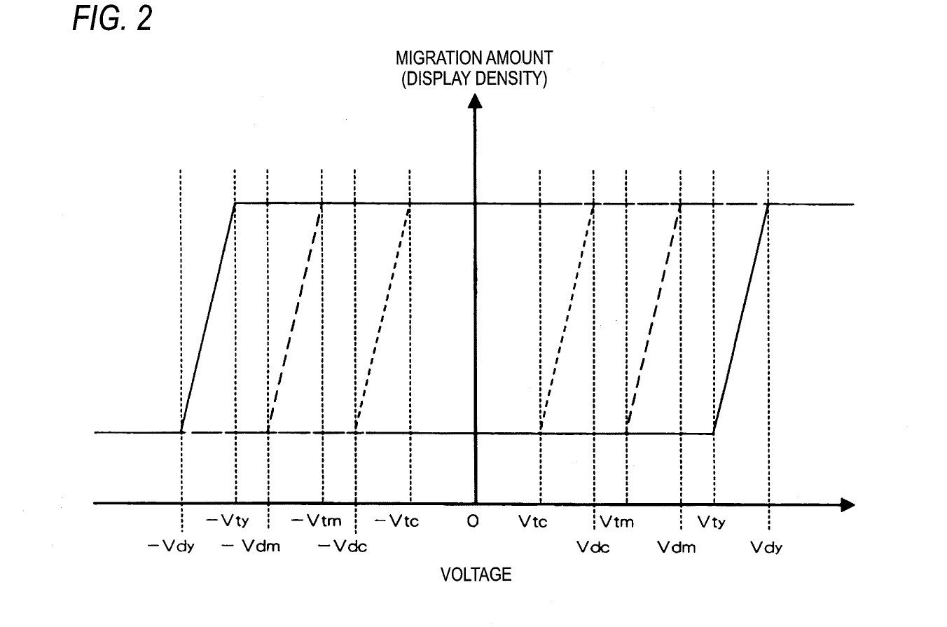

Here, as shown in FIG. 2, in the display medium 12, the absolute value of the voltage necessary for inducing movement in accordance with an electric field when the particle group 34 electrophoretically migrates between the substrates differs from one color to another in the particle group 34 as described above. For respective colors, the particle group 34 of each color has a voltage range necessary for inducing movement of the particle group 34 of each color, and this voltage range differs from each other. In other words, the absolute value of the voltage has the above-described voltage range, and the voltage range differs from one color to another in the particle group 34.

In this exemplary embodiment, the particle group 34 enclosed in the same cell of the display medium 12 is described on the assumption that, as shown in FIG. 1, particle groups 34 of three colors, that is, a magenta particle 34M of magenta color, a cyan particle group 34C of cyan color, and a yellow particle group 34Y of yellow color, are enclosed.

Also, the absolute values of the voltages when respective particle groups of three colors, that is, the magenta particle group 34M of magenta color, the cyan particle group 34C of cyan color, and the yellow particle group 34Y of yellow color, start moving are described on the assumption that the absolute value is |Vtm| for the magenta particle group 34M of magenta color, |Vtc| for the cyan particle group 34C of cyan color, and |Vty| for the yellow particle group 34Y of yellow color. Furthermore, the absolute values of the maximum voltages for almost entirely moving respective particle groups 34 of three colors, that is, the magenta particle group 34M of magenta color, the cyan particle group 34C of cyan color, and the yellow particle group 34Y of yellow color, are described on the assumption that the absolute value is |Vdm| for the magenta particle group 34M of magenta color, |Vdc| for the cyan particle group 34C of cyan color, and |Vdy| for the yellow particle group 34Y of yellow color.

In the following, the absolute values of Vtc, −Vtc, Vdc, −Vdc, Vtm, −Vtm, Vdm, −Vdm, Vty, −Vty, Vdy and −Vdy are described on the assumption that these absolute values have a relationship of |Vtc|<|Vdc|<|Vtm|<|Vdm|<|Vty|<|Vdy|.

Specifically, as shown in FIG. 2, for example, all of the particle groups 34 are charged to the same polarity, and the absolute value |Vtc≦Vc≦Vdc| (the absolute value between Vtc and Vdc) of the voltage range necessary for inducing movement of the cyan particle group 34C, the absolute value |Vtm≦Vm≦Vdm| (the absolute value between Vtm and Vdm) of the voltage range necessary for inducing movement of the magenta particle group 34M, and the absolute value |Vty≦Vy≦Vdy| (the absolute value between Vty and Vdy) of the voltage range necessary for inducing movement of the yellow particle group 34Y, are set to increase in this order without overlapping one another.

Also, for independently driving the particle group 34 of each color, the absolute value |Vdc| of the maximum voltage for almost entirely moving the cyan particle group 34C is set to be lower than the absolute value |Vtm≦Vm≦Vdm| (the absolute value between Vtm and Vdm) of the voltage range necessary for moving the magenta particle group 34M and the absolute value |Vty≦Vy≦Vdy| (the absolute value between Vty and Vdy) of the voltage range necessary for moving the yellow particle group 34Y. In addition, the absolute value |Vdm| of the maximum voltage for almost entirely moving the magenta particle group 34M is set to be lower than the absolute value |Vty≦Vy≦Vdy| (the absolute value between Vty and Vdy) of the voltage range necessary for moving the yellow particle group 34Y.

That is, in this exemplary embodiment, the particle group 34 of each color is independently driven by setting the voltage ranges necessary for moving the particle groups 34 of respective colors so as not to overlap one another.

The “voltage range necessary for inducing movement of the particle group 34” as used herein indicates a voltage range from a voltage necessary for staring the movement of the particle to a voltage at which no change occurs in the display density despite further increasing the voltage and the voltage application time from those at the start of movement and the display density is saturated.

Also, the “maximum voltage necessary for almost entirely moving the particle group 34” indicates a voltage at which no change occurs in the display density despite further increasing the voltage and the voltage application time from those at the start of movement and the display density is saturated.

The “almost entirely” indicates that because of variations in the characteristics of the particle groups 34 of respective colors, a part of the particle group 34 exhibits different characteristics to such an extent not to contribute to the display characteristics. In other words, this is a state where no change occurs in the display density despite further increasing the voltage and the voltage application time from those at the start of movement and the display density is saturated.

The “display density” indicates a density when in the course of applying a voltage between the display surface side and the back surface side by gradually changing the voltage (increasing or decreasing the applied voltage) to increase the measured density while measuring the color density (Optical Density=OD) on the display surface side by means of a reflection densitometer manufactured by X-rite, the change in density per unit voltage is saturated and despite increasing the voltage and the voltage application time in that state, the density shows the saturated density without causing any change in the density.

In the display medium 12 according to this exemplary embodiment, when a voltage is applied between substrates of the display substrate 20 and the back surface substrate 22 starting from 0 V by gradually raising the voltage value of the applied voltage and the voltage applied between the substrates exceeds +Vtc, the display density starts changing due to movement of the cyan particle group 34C in the display medium 12. Furthermore, when the voltage value is raised and the voltage applied between substrates reaches +Vdc, the change in the display density due to movement of the cyan particle group 34C in the display medium 12 stops.

When the voltage value is further raised and the voltage applied between substrates of the display substrate 20 and the back surface substrate 22 exceeds +Vtm, the display density starts changing due to movement of the magenta particle group 34M in the display medium 12. Furthermore, when the voltage value is raised and the voltage applied between substrates of the display substrate 20 and the back surface substrate 22 reaches +Vdm, the change in the display density due to movement of the magenta particle group 34M in the display medium 12 stops.

Furthermore, when the voltage value is raised and the voltage applied between substrates exceeds +Vty, the display density starts changing due to movement of the yellow particle group 34Y in the display medium 12. When the voltage value is further raised and the voltage applied between substrates reaches +Vdy, the change in the display density due to movement of the yellow particle group 34Y in the display medium 12 stops.

On the contrary, when a negative voltage is applied between substrates of the display substrate 20 and the back surface substrate 22 starting from 0 V by gradually raising the absolute value of the voltage and the absolute value of the voltage applied between substrates exceeds the absolute value of −Vtc, the display density starts changing due to movement of the cyan particle group 34C between substrates in the display medium 12. Furthermore, when the absolute value of the voltage value is raised and the voltage applied between substrates of the display substrate 20 and the back surface substrate 22 reaches −Vdc or more, the change in the display density due to movement of the cyan particle group 34C in the display medium 12 stops.

When a negative voltage is applied by further raising the absolute value of the voltage value and the voltage applied between substrates of the display substrate 20 and the back surface substrate 22 exceeds the absolute value of −Vtm, the display density starts changing due to movement of the magenta particle group 34M in the display medium 12. Furthermore, when the absolute value of the voltage value is raised and the voltage applied between substrates of the display substrate 20 and the back surface substrate 22 reaches −Vdm, the change in the display density due to movement of the magenta particle group 34M in the display medium 12 stops.

When a negative voltage is applied by further raising the absolute value of the voltage value and the voltage applied between substrates of the display substrate 20 and the back surface substrate 22 exceeds the absolute value of −Vty, the display density starts changing due to movement of the yellow particle group 34Y in the display medium 12. Furthermore, when the absolute value of the voltage value is raised and the voltage applied between substrates reaches −Vdy, the change in the display density due to movement of the yellow particle group 34Y in the display medium 12 stops.

That is, in this exemplary embodiment, as shown in FIG. 2, in the case where a voltage allowing the voltage applied between substrates to fall in the range of −Vtc to Vtc (the voltage range of |Vtc| or less) is applied between substrates of the display substrate 20 and the back surface substrate 22, the particle of the particle group 34 (the cyan particle group 34C, the magenta particle group 34M, and the yellow particle group 34Y) is kept from such an extent of movement as causing a change in the display density of the display medium 12. When a voltage not lower than the absolute value of a voltage +Vtc and a voltage −Vtc is applied between substrates, out of the particle groups 34 of three colors, the particle of the cyan particle group 34C starts moving to such an extent as causing a change in the display density of the display medium 12 and the display density starts changing, and when a voltage not lower than the absolute value |Vdc| of a voltage −Vdc and a voltage Vdc is applied, the display density per unit voltage stops changing.

Furthermore, in the case where a voltage allowing the voltage applied between substrates to fall in the range of −Vtm to Vtm (the voltage range of |Vtm| or less) is applied between substrates of the display substrate 20 and the back surface substrate 22, the particles of the magenta particle group 34M and the yellow particle group 34Y are kept from such an extent of movement as causing a change in the display density of the display medium 12. When a voltage not lower than the absolute value of a voltage +Vtm and a voltage −Vtm is applied between substrates, out of the magenta particle group 34M and the yellow particle group 34Y, the particle of the magenta particle group 34M starts moving to such an extent as causing a change in the display density of the display medium 12 and the display density per unit voltage starts changing, and when a voltage not lower than the absolute value |Vdm| of a voltage −Vdm and a voltage Vdm is applied, the display density stops changing.

Furthermore, in the case where a voltage allowing the voltage applied between substrates to fall in the range of −Vty to Vty (the voltage range of |Vty| or less) is applied between substrates of the display substrate 20 and the back surface substrate 22, the particles of the yellow particle group 34Y is kept from such an extent of movement as causing a change in the display density of the display medium 12. When a voltage not lower than the absolute value of a voltage +Vty and a voltage −Vty is applied between substrates, the particle of the yellow particle group 34Y starts moving to such an extent as causing a change in the display density of the display medium 12 and the display density starts changing, and when a voltage not lower than the absolute value |Vdy| of a voltage −Vdy and a voltage Vdy is applied, the display density stops changing.

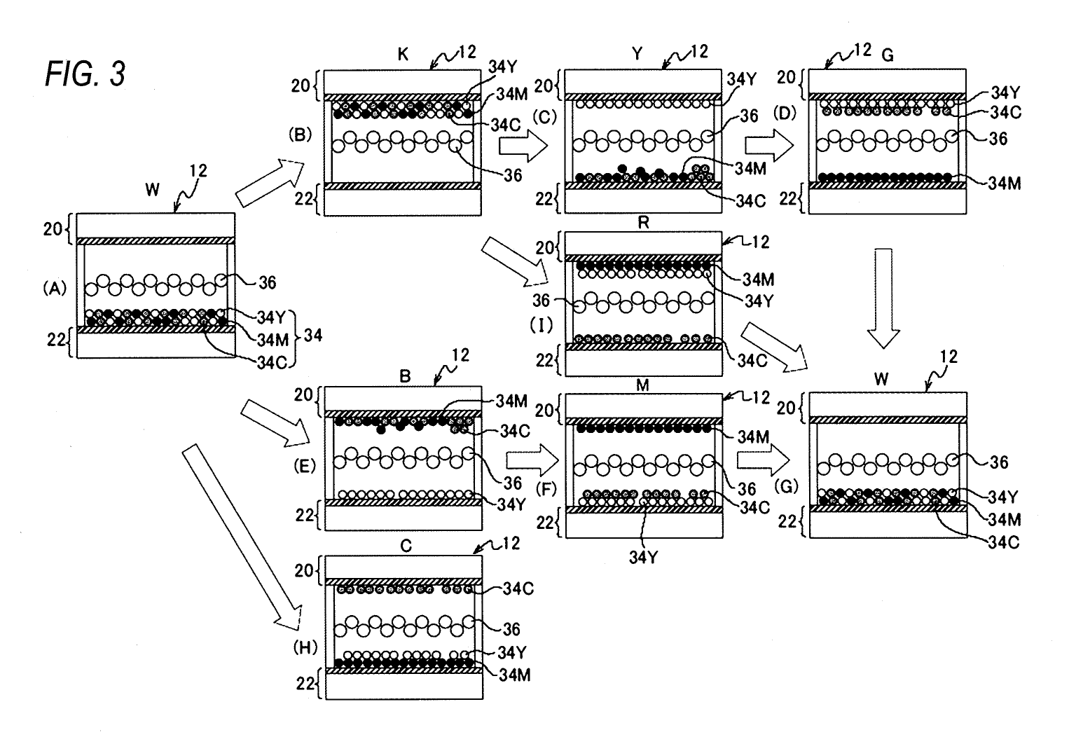

The mechanism of particle movement when displaying an image on the display medium 12 of the present invention is described below by referring to FIG. 3.

The mechanism is described, for example, on the assumption that in a display medium 12, the yellow particle group 34Y, the magenta particle group 34M and the cyan particle group 34C described by referring to FIG. 2 are enclosed as a plurality of kinds of particle groups 34.

In the following description, the voltage ranging from not less than the absolute value of the voltage necessary for starting movement of the particle constituting the yellow particle group 34Y to not more than the above-described maximum voltage for the yellow particle group 34Y and being applied between substrates is referred to as “large voltage”; the voltage ranging from not less than the absolute value of the voltage necessary for starting movement of the particle constituting the magenta particle group 34M to not more than the above-described maximum voltage for the magenta particle group 34M and being applied between substrates is referred to as “medium voltage”; and the voltage ranging from not less than the absolute value of the voltage necessary for starting movement of the particle constituting the cyan particle group 34C to not more than the above-described maximum voltage for the cyan particle group 34C and being applied between substrates is referred to as “small voltage”.

Also, in the case where a voltage that is higher on the display substrate 20 side than on the back surface substrate 22 side is applied between substrates, the voltages are referred to as “+large voltage”, “+medium voltage”, and “+small voltage”, respectively. On the other hand, in the case where a voltage that is higher on the back surface substrate 22 side than on the display substrate 20 side is applied between substrates, the voltages are referred to as “+large voltage”, “+medium voltage”, and “+small voltage”, respectively.

As shown in FIG. 3(A), assuming that all of the magenta particle group 34M, the cyan particle group 34C, and the yellow particle group 34Y as all particle groups are located on the back surface substrate 22 side in the initial state, when a “+large voltage” is applied between the display substrate 20 and the back surface substrate 22 in this initial state, the magenta particle group 34M, the cyan particle group 34C, and the yellow particle group 34Y as all particle groups move to the display substrate 20 side. Even when the voltage application is terminated in this state, each of respective particle groups remains attached on the display substrate 20 side without moving, and a state where a black color is left displayed by the subtractive color mixing of the magenta particle group 34M, the cyan particle group 34C, and the yellow particle group 34Y (subtractive color mixing of magenta, cyan and yellow colors) is created (see FIG. 3(B)).

Then, when a “−medium voltage” is applied between the display substrate 20 and the back surface substrate 22 in the state of FIG. 3(B), out of the particle groups 34 of all colors, the magenta particle group 34M and the cyan particle group 34C move to the back surface substrate 22 side. Accordingly, a state of only the yellow particle group 34Y being attached on the display substrate 20 side is created, as a result, a yellow color is displayed (see FIG. 3(C)).

Furthermore, when a “+small voltage” is applied between the display substrate 20 and the back surface substrate 22 in the state of FIG. 3(C), out of the magenta particle group 34M and the cyan particle group 34C moved to the back surface substrate 22 side, the cyan particle group 34C moves to the display substrate 20 side. Accordingly, a state of the yellow particle group 34Y and the cyan particle group 34C being attached on the display substrate 20 side is created, and a green color by the subtractive color mixing of yellow and cyan is displayed (see FIG. 3D).

Also, when a “−small voltage” is applied between the display substrate 20 and the back surface substrate 22 in the state of FIG. 3(B), out of all particle groups 34, the cyan particle group 34C moves to the back surface substrate 22 side. Accordingly, a state of the yellow particle group 34Y and the magenta particle group 34M being attached on the display substrate 20 side is created, and a red color by the additive color mixing of yellow and magenta is displayed (see FIG. 3(I)).

On the other hand, when a “+medium voltage” is applied between the display substrate 20 and the back surface substrate 22 in the initial state shown in FIG. 3(A), out of all particle groups 34 (the magenta particle group 34M, the cyan particle group 34C, and the yellow particle group 34Y), the magenta particle group 34M and the cyan particle group 34C move to the display substrate 20 side. Accordingly, the magenta particle group 34M and the cyan particle group 34C are attached on the display substrate 20 side, and a blue color by the subtractive color mixing of magenta and cyan is displayed (see FIG. 3(E)).

When a “−small voltage” is applied between the display substrate 20 and the back surface substrate 22 in the state of FIG. 3(E), out of the magenta particle group 34M and the cyan particle group 34C attached on the display substrate 20 side, the cyan particle group 34C moves to the back surface substrate 22 side.

Accordingly, a state of only the magenta particle group 34M being attached on the display substrate 20 side is created, and a magenta color is displayed (see FIG. 3(F)).

When a “−large voltage” is applied between the display substrate 20 and the back surface substrate 22 in the state of FIG. 3(F), the magenta particle group 34M attached on the display substrate 20 side moves to the back surface substrate 22 side.

Accordingly, a state of no particle being attached on the display substrate 20 side is created, and a white color that is the color of the insulating particle 36 is displayed (see FIG. 3(G)).

Also, when a “+small voltage” is applied between the display substrate 20 and the back surface substrate 22 in the initial state shown in FIG. 3(A), out of all particle groups 34 (the magenta particle group 34M, the cyan particle group 34C, and the yellow particle group 34Y), the cyan particle group 34C moves to the display substrate 20 side. Accordingly, the cyan particle group 34C is attached on the display substrate 20 side, and a cyan color is displayed (see FIG. 3(H)).

Furthermore, when a “−large voltage” is applied between the display substrate 20 and the back surface substrate 22 in the state shown in FIG. 3(I), all particle groups 34 move to the back surface substrate 22 side as shown in FIG. 3(G), and a white color may be displayed.

Similarly, when a “−large voltage” is applied between the display substrate 20 and the back surface substrate 22 in the state shown in FIG. 3(D), all particle groups 34 move to the back surface substrate 22 side as shown in FIG. 3(G), and a white color is displayed.

As described above, in this exemplary embodiment, a voltage according to each particle group 34 is applied between substrates, and a desired particle group is thereby selectively moved in accordance with an electric field formed by the voltage, so that a particle having a color other than the desired color can be prevented from moving in the dispersion medium 50 and a color display can be achieved while reducing color mixture due to mixing of a color other than the desired color and suppressing deterioration of the image quality on the display medium 12. Incidentally, as long as respective particle groups 34 differ from each other in the absolute value of the voltage necessary for inducing movement in accordance with an electric field, a vivid color display may be realized even when the voltage range necessary for inducing movement in accordance with an electric field overlaps one another, but in the case of differing from each other in the voltage range, a color display is realized by more successfully reducing color mixture.

Also, the particle groups 34 of three colors consisting of cyan, magenta and yellow are dispersed in the dispersion medium 50, whereby not only cyan, magenta, yellow, blue, red, green and black colors can be displayed but also a white color can be displayed owing to the white insulating particle 36, as result, a desired color display can be achieved.

### EXAMPLES

The present invention is described in greater detail below by referring to Examples.

In the following, unless otherwise indicated, the “parts” is on the mass basis.

### (Production of White Particle)

In a 100 ml-volume three-neck flask equipped with a reflux condenser, 5 parts of 2-vinylnaphthalene, 5 parts of SILAPLANE FM-0721 (linear silicone-based monomer, weight average molecular weight: 5,000, produced by Chisso Corp.), 0.3 parts of lauroyl peroxide (polymerization initiator, produced by Wako Pure Chemical Industries, Ltd.) and 20 parts of dimethyl silicone oil (KF-96L-1CS, produced by Shin-Etsu Chemical Co., Ltd.) were charged and after bubbling with a nitrogen gas for 15 minutes, polymerization was performed at 65° C. for 24 hours in a nitrogen atmosphere. The obtained white particle was adjusted to a solid content concentration of 33 mass % with the silicone oil above to prepare a white particle dispersion liquid. The volume average particle diameter of the white particle was 0.45 μm.

### (Production of Cyan Particle)

19 Parts of SILAPLANE FM-0725 (linear silicone-based monomer, weight average molecular weight: 10,000, produced by Chisso Corp.), 29 parts of SILAPLANE FM-0721 (linear silicone-based monomer, weight average molecular weight: 5,000, produced by Chisso Corp.), 9 parts of methyl methacrylate, 5 parts of octafluoropentyl methacrylate, and 38 parts of 2-hydroxyethyl methacrylate were mixed with 300 parts of isopropyl alcohol and after dissolving a part of azobisisobutyronitrile (AIBN, polymerization initiator, produced by Aldrich Chemical Co. Inc.), polymerization was performed at 70° C. for 6 hours under nitrogen. The obtained product was purified by using hexane as a reprecipitation solvent and then dried to obtain Silicone-Based Polymer A.

After adding and dissolving 0.5 g of Silicone-Based Polymer A in 9 g of isopropyl alcohol, 0.5 g of a cyan pigment (Cyanine Blue 4973, produced by Sanyo Color Works, Ltd.) was added thereto and dispersed for 48 hours by using zirconia balls having a diameter of 0.5 mm to obtain a pigment-containing polymer solution.

Subsequently, 3 g of the pigment-containing polymer solution was weighed and after heating the solution at 40° C., 12 g of dimethyl silicone oil (KF-96L-2CS, produced by Shin-Etsu Chemical Co., Ltd.) was added dropwise little by little while applying an ultrasonic wave, whereby Silicone-Based Polymer A was precipitated on the pigment surface. Thereafter, isopropyl alcohol was evaporated by heating the solution at 60° C. under reduced pressure to obtain a cyan particle where Silicone-Based Polymer A is attached to the pigment surface. The particle of the solution was precipitated by using a centrifugal separator and after removing the supernatant solution, 5 g of the silicone oil above was added, followed by washing under ultrasonic wave application. Furthermore, the particle was precipitated by using a centrifugal separator and after removing the supernatant solution, 5 g of the silicone oil above was added to obtain a cyan particle dispersion liquid. The volume average particle diameter of the cyan particle was 0.3 μm.

The charged polarity of the particle in the cyan particle dispersion liquid was evaluated by enclosing the dispersion liquid between two electrode substrates and applying a dc voltage while observing the migration direction, as a result, the particle was found to be negatively charged.

### (Production of Large-Diameter Red Particle R1)

44.5 Parts of methyl methacrylate, 0.5 parts of 2-(diethylamino)ethyl methacrylate and 5 parts of a red pigment (Pigment Red 3 0906, produced by Sanyo Color Works, Ltd.) were mixed, and the mixture was subjected to ball mill pulverization for 20 hours by using zirconia balls having a diameter of 10 mm to prepare Dispersion Liquid A-1. Subsequently, 40 parts of calcium carbonate and 60 parts of water were mixed, and the mixture was pulverized by the same ball mill as above to prepare Calcium Carbonate Dispersion Liquid A-2. Furthermore, 4 g of Calcium Carbonate Dispersion Liquid A-2 and 60 g of a 20% saline solution were mixed, and the mixture was subjected to deaeration by an ultrasonic device for 10 minutes and then stirring in an emulsifying machine to prepare Mixed Solution A-3.

Thereafter, 20 g of Dispersion Liquid A-1, 0.6 g of ethylene glycol dimethacrylate and 0.2 g of dimethyl 2,2′-azobis(2-methylpropionate) (polymerization initiator, V-601, produced by Wako Pure Chemical Industries, Ltd.) were thoroughly mixed, and the mixture was deaerated by an ultrasonic device for 10 minutes and then added to Mixed Solution A-3. The resulting mixture was emulsified in an emulsifying machine, and this emulsified liquid was put into a flask, and the flask was plugged with a silicone stopper, subjected to pressure reduction/deaeration by using an injection needle, and then sealed with a nitrogen gas. The reaction was allowed to proceed at 65° C. for 15 hours to obtain particles, and the particles were cooled and then filtered. The obtained particle powder was dispersed in ion-exchanged water and after decomposing calcium carbonate with hydrochloric acid, the particles were filtered, then thoroughly washed with distilled water and passed through nylon sieves having an opening of 15 μm and 10 μm to regulate the particle size. The volume average particle diameter of the obtained particles was 13 μm.

The red particle obtained above is referred to as Large-Diameter Red Particle R0.

Thereafter, Large-Diameter Red Particle R0 was subjected to the following surface treatment.

95 Parts of VTT-106 (produced by Gelest, a monomer represented by formula (III)), 2 parts of glycidyl methacrylate and 3 parts of methyl methacrylate were mixed with 300 parts of isopropyl alcohol and after dissolving 1 part of azobisisobutyronitrile (polymerization initiator, AIBN, produced by Aldrich Chemical Co. Inc.) therein, polymerization was performed at 70° C. for 6 hours under nitrogen. Thereafter, 300 parts of dimethyl silicone oil (KF-96L-2CS, produced by Shin-Etsu Chemical Co., Ltd.) was added, and isopropyl alcohol was removed under reduced pressure to obtain a branched silicone-based polymer. This branched silicone-based polymer is referred to as Surface-Treating Agent B-1.

Subsequently, 2 parts of Large-Diameter Red Particle R0, 25 parts of Surface-Treating Agent B-1 and 0.01 parts of triethylamine were mixed and stirred at a temperature of 100° C. for 5 hours. The solvent was then removed by centrifugal sedimentation, and the residue was dried under reduced pressure to obtain Large-Diameter Particle R1 where a branched silicone-based polymer is attached by bonding to the surface of Large-Diameter Red Particle R0.

The volume average particle diameter of Large-Diameter Red Particle R1 was 13 μm, and the charged polarity was a positively charged polarity.

### (Production of Large-Diameter Red Particle R2)

Large-Diameter Red Particle R2 was produced thoroughly in the same manner as Large-Diameter Red Particle R1 except for using RTT-1011 (produced by Gelest, a monomer represented by formula (II)) in place of VTT-106. The volume average particle diameter of Large-Diameter Red Particle R2 was 13 μm, and the charged polarity was a positively charged polarity.

### (Production of Large-Diameter Red Particle R3)

Large-Diameter Red Particle R3 was produced thoroughly in the same manner as Large-Diameter Red Particle R1 except for using MCS-M11 (produced by Gelest, a monomer represented by formula (I)) in place of VTT-106. The volume average particle diameter of Large-Diameter Red Particle R3 was 13 μm, and the charged polarity was a positively charged polarity.

### (Production of Large-Diameter Red Particle R4)

Large-Diameter Red Particle R4 was produced thoroughly in the same manner as Large-Diameter Red Particle R1 except for using MFS-M15 (produced by Gelest, a monomer represented by formula (I)) in place of VTT-106. The volume average particle diameter of Large-Diameter Red Particle R4 was 13 μm, and the charged polarity was a positively charged polarity.

### (Production of Large-Diameter Red Particle R01)

Large-Diameter Red Particle R01 was produced by not applying the surface treatment to Large-Diameter Red Particle R0. The volume average particle diameter of Large-Diameter Red Particle R01 was 13 μm, and the charged polarity was a positively charged polarity.

### (Production of Large-Diameter Red Particle R02)

Large-Diameter Red Particle R0 was subjected to the following surface treatment.

95 Parts of SILAPLANE FM-0711 (linear silicone-based monomer, produced by Chisso Corp.), 2 parts of glycidyl methacrylate and 3 parts of methyl methacrylate were mixed with 300 parts of isopropyl alcohol and after dissolving 1 part of azobisisobutyronitrile (polymerization initiator, AIBN, produced by Aldrich Chemical Co. Inc.) therein, polymerization was performed at 70° C. for 6 hours under nitrogen. Thereafter, 300 parts of dimethyl silicone oil (KF-96L-2CS, produced by Shin-Etsu Chemical Co., Ltd.) was added, and isopropyl alcohol was removed under reduced pressure to obtain a linear silicone-based polymer. This linear silicone-based polymer is referred to as Surface-Treating Agent B-2.

Subsequently, 2 parts of Large-Diameter Red Particle R0, 25 parts of Surface-Treating Agent B-2 and 0.01 parts of triethylamine were mixed and stirred at a temperature of 100° C. for 5 hours. The solvent was then removed by centrifugal sedimentation, and the residue was dried under reduced pressure to obtain Large-Diameter Particle R02 where a linear silicone-based polymer is attached by bonding to the surface of Large-Diameter Red Particle R0.

The volume average particle diameter of Large-Diameter Red Particle R02 was 13 μm, and the charged polarity was a positively charged polarity.

### (Production of Large-Diameter Red Particle R03)

45 Parts of MCS-M11 (produced by Gelest, a monomer represented by formula (I)) and 5 parts of methacrylic acid (produced by Wako Pure Chemical Industries, Ltd.) were mixed with 100 parts of isopropyl alcohol and after dissolving 0.2 parts of azobisisobutyronitrile (polymerization initiator, V-65, produced by Wako Pure Chemical Industries, Ltd.) therein, polymerization was performed at 60° C. for 6 hours under nitrogen. Thereafter, 300 parts of dimethyl silicone oil (KF-96L-2CS, produced by Shin-Etsu Chemical Co., Ltd.) was added, and isopropyl alcohol was removed under reduced pressure to obtain a branched silicone-based polymer. This branched silicone-based polymer is referred to as Surface-Treating Agent B-3. Surface-Treating Agent B-3 is a branched silicone-based polymer containing no reactive copolymerization component.

Subsequently, 2 parts of Large-Diameter Red Particle R0 and 25 parts of Surface-Treating Agent B-3 were mixed and stirred/mixed for 5 hours. The solvent was then removed by centrifugal sedimentation, and the residue was dried under reduced pressure to obtain Large-Diameter Particle R03.

Large-Diameter Red Particle R03 is considered to be a particle where the surface of Large-Diameter Red Particle R0 is covered with Surface-Treating Agent B-3 by an acid-base interaction between an amino group contained in Large-Diameter Red Particle R0 and a carboxyl group contained in Surface-Treating Agent B-3.

The volume average particle diameter of Large-Diameter Red Particle R03 was 13 μm, and the charged polarity was a positively charged polarity.

### Example 1

On a substrate composed of a 0.7 mm-thick glass, ITO (indium tin oxide) was deposited as an electrode by sputtering to a thickness of 50 nm. Two sheets of this ITO/glass substrate were prepared and used as a first substrate (first electrode) and a second substrate (second electrode). The second substrate was put on top of the first substrate by using a 50 μm-thick Teflon (registered trademark) as a spacer and fixed by clips.

Thereafter, a mixed solution obtained by mixing 10 parts of the white particle dispersion liquid, 2 parts of the cyan particle dispersion liquid and 2.1 parts of Large-Diameter Red Particle R1 was poured into a space between the substrates above, and this was used as a cell for evaluation.

Using the cell for evaluation produced above, a voltage of 30 V was applied to both electrodes for 1 second such that the second electrode serves as the positive electrode. The cyan particle (negatively charged) moved to the positive electrode side, that is, the second electrode side, the red particle (positively charged) moved to the negative electrode side, that is, the first electrode side, and when watched from the second substrate side, a cyan color was observed.

Subsequently, a voltage of 30 V was applied to both electrodes for 1 second such that the second electrode serves as the negative electrode, as a result, the red particle moved to the negative electrode side, that is, the second electrode side, the cyan particle moved to the positive electrode side, that is, the first electrode side, and when watched from the second substrate side, a red color was observed as the display color.

In the state of a red color being observed, the second electrode was examined with an optical microscope, as a result, only a red particle was observed and a cyan particle was not found.

Furthermore, the reflectance was measured at a wavelength of 650 nm and a wavelength of 500 nm by using a spectrophotometric colorimeter, CM-2022, manufactured by Minolta Co., Ltd. The results are shown in Table 1.

### Examples 2 to 4

Observation of the display color and examination with an optical microscope were performed and the reflectance was measured thoroughly in the same manner as in Example 1 except for using any of Large-Diameter Red Particles R2 to R4 in place of Large-Diameter Red Particle R1. The results are shown in Table 1.

### Comparative Examples 1 to 3

Observation of the display color and examination with an optical microscope were performed and the reflectance was measured thoroughly in the same manner as in Example 1 except for using any of Large-Diameter Red Particles R01 to R03 in place of Large-Diameter Red Particle R1. The results are shown in Table 1.

TABLE 1

| | | Silicone Chain | | | | |
|---|---|---|---|---|---|---|
| | | Component | Reflectance | | | |
| | Red | Contained in Surface- | at | Reflectance at | | Results of Examination with Optical |
| | Particle | Treating Agent | 650 nm [%] | 500 nm [%] | Display Color | Microscope |
| Example 1 | R1 | VTT-106 | 38.0 | 3.2 | red | No cyan particle is found around red |
| | | | | | | particle. |
| Example 2 | R2 | RTT-1011 | 38.2 | 3.1 | red | No cyan particle is found around red |
| | | | | | | particle. |
| Example 3 | R3 | MCS-M11 | 38.2 | 3.2 | red | No cyan particle is found around red |
| | | | | | | particle. |
| Example 4 | R4 | MFS-M15 | 38.5 | 3.6 | red | No cyan particle is found around red |
| | | | | | | particle. |
| Comparative | R01 | no surface treatment | 20.2 | 3.2 | slightly blue-tinted | A large number of cyan particles are |
| Example 1 | | | | | red | found around red particle. |
| Comparative | R02 | FM-0711 | 30.5 | 3.3 | red | A small number of cyan particles are |
| Example 2 | | | | | | found around red particle. |
| Comparative | R03 | MCS-M11 | 22.3 | 3.1 | slightly blue-tinted | A large number of cyan particles are |
| Example 3 | | | | | red | found around red particle. |

It is seen from the evaluation results shown in Table 1 that the red particle of Examples is kept from adherence to a cyan particle having a smaller particle diameter than the red particle, as compared with the red particle of Comparative Examples.

What is claimed is:

1. An electrophoretic particle, comprising:
a colored particle containing a charged group-containing polymer and a coloring agent, and
a branched silicone-based polymer being attached to said colored particle and containing, as copolymerization components, a reactive monomer and at least one monomer selected from a monomer represented by the following formula (I), a monomer represented by the following formula (II) and a monomer represented by the following formula (III): 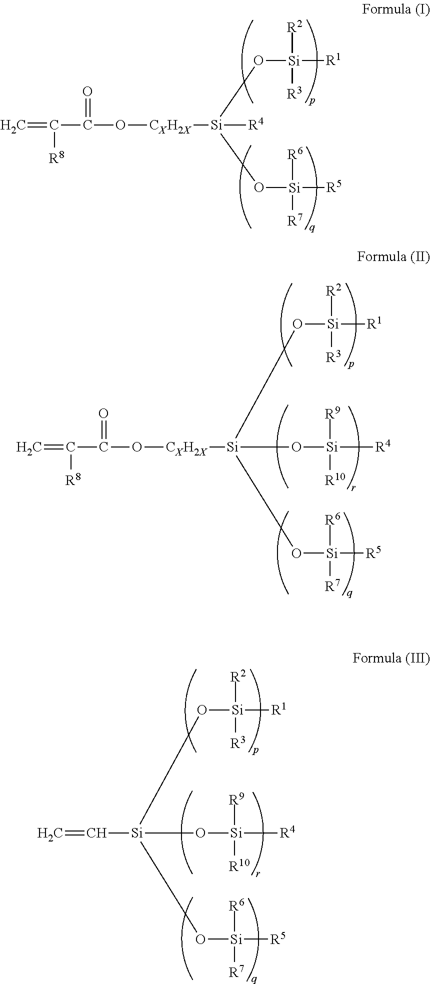
wherein in formula (I), formula (II) and formula (III), each of R¹, R², R³, R⁴, R⁵, R⁶, R⁷, R⁹ and R¹⁰ independently represents a hydrogen atom, an alkyl group having a carbon number of 1 to 4, or a fluoroalkyl group having a carbon number of 1 to 4,
R⁸ represents a hydrogen atom or a methyl group,
each of p, q and r independently represents an integer of 1 to 1,000, and
x represents an integer of 1 to 3.

2. A particle dispersion liquid for display, comprising:
a first particle group composed of a first electrophoretic particle comprising a colored particle containing a charged group-containing polymer and a coloring agent, and a branched silicone-based polymer being attached to the colored particle and containing, as copolymerization components, a reactive monomer and at least one monomer selected from a monomer represented by the following formula (I), a monomer represented by the following formula (II) and a monomer represented by the following formula (III),
a second particle group composed of a second electrophoretic particle exhibiting a color different from the first electrophoretic particle and having a smaller particle diameter than the first electrophoretic particle, and
a dispersion medium: 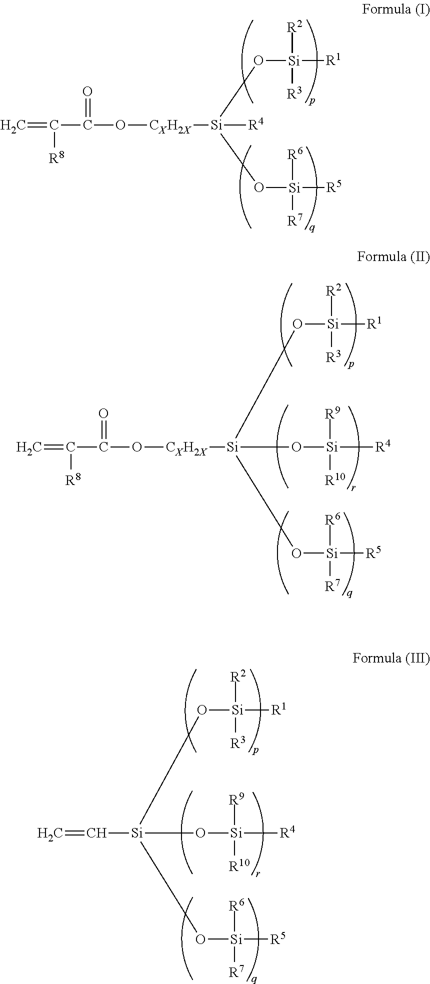
wherein in formula (I), formula (II) and formula (III), each of R¹, R², R³, R⁴, R⁵, R⁶, R⁷, R⁹ and R¹⁰ independently represents a hydrogen atom, an alkyl group having a carbon number of 1 to 4, or a fluoroalkyl group having a carbon number of 1 to 4,
R⁸ represents a hydrogen atom or a methyl group,
each of p, q and r independently represents an integer of 1 to 1,000, and
x represents an integer of 1 to 3.

3. A display medium comprising:
a pair of substrates, with at least one substrate having transparency to light, and
the particle dispersion liquid for display according to claim 2, which is enclosed between the pair of substrates.

4. A display medium comprising:
a pair of electrodes, with at least one electrode having transparency to light, and
a region having the particle dispersion liquid for display according to claim 2, which is provided between the pair of electrodes.

5. A display device comprising:
the display medium according to claim 3, and
a voltage applying unit that applies a voltage between the pair of substrates of the display medium.

6. A display device comprising:
the display medium according to claim 4, and
a voltage applying unit that applies a voltage between the pair of electrodes of the display medium.
